(19) United States
(12) Patent Application Publication
(10) Pub. No.: US 2026/0197070 A1
(43) Pub. Date: Jul. 9, 2026

(54) METHOD AND APPARATUS FOR DETECTING BEAM FAILURE

(71) Applicant: 1FINITY Inc., Kawasaki-shi (JP)

(72) Inventors: Meiyi JIA, Beijing (CN); Xin WANG, Beijing (CN); Yang LU, Beijing (CN); Su YI, Beijing (CN)

(73) Assignee: 1FINITY Inc., Kawasaki-shi (JP)

(21) Appl. No.: 19/554,828

(22) Filed: Mar. 3, 2026

Related U.S. Application Data
(63) Continuation of application No. 18/218,700, filed on Jul. 6, 2023, now Pat. No. 12,597,980.
Application No. 18/218,700 is a continuation of application No. PCT/CN2021/071617, filed on Jan. 13, 2021.

(51) Int. Cl. H04B 7/06

(52) U.S. Cl. CPC H04B 7/06964; H04B 7/06954

(57) ABSTRACT

An apparatus for detecting beam failure for a beam failure detection reference signal set of a serving cell includes: a receiver configured to receive a beam failure instance indication in each of two beam failure detection reference signal sets configured for a serving cell; and processor circuitry configured to: increment, when the receiver receives a beam failure instance indication in a BFD-RS set which is included in the two BFD-RS sets, a beam failure indication count of the BFD-RS set by 1, trigger, in a case where the beam failure indication count of the BFD-RS set is greater than or equal to a beam failure instance maximum count for BFD-RS set, beam failure recovery for the BFD-RS set of the serving cell.

### CROSS-REFERENCE TO RELATED APPLICATION

This application is a continuation application of U.S. application Ser. No. 18/218,700 filed on Jul. 6, 2023, which is a continuation application of International Application PCT/CN2021/071617 filed on Jan. 13, 2021, and designated the U.S., the entire contents of each are incorporated herein by reference.

### TECHNICAL FIELD

Embodiments of the present application relate to the field of communication technology.

### BACKGROUND

In a new new radio (NR) system, transmission and reception of beams are supported, and management of multiple beams is supported. A terminal equipment may perform a beam failure detection (BFD) procedure and a beam failure recovery (BFR) procedure.

In 3GPP Rel-15/16, a medium access control (MAC) entity may be configured by radio resource control (RRC) per serving cell with a beam failure recovery procedure. When beam failure is detected on serving synchronization signal block(s) (SSB(s))/channel state information reference signals (CSI-RS(s)), a new SSB or CSI-RS is indicated to a serving network device (e.g., gNB).

When a MAC protocol data unit (PDU) is transmitted by the terminal equipment to the network device, and the MAC PDU includes a BFR MAC control element (CE) or a truncated BFR MAC CE which contains beam failure information of a secondary cell, the terminal equipment shall cancel all BFRs triggered for beam failure recovery in the secondary cell before the MAC PDU assembly.

In the beam failure recovery procedure, the MAC entity will execute the following operation:

If the beam failure recovery procedure determines that at least one BFR has been triggered and not cancelled, an evaluation of its candidate beams has been completed according to the requirements:
If uplink resources (UL-SCH resources) are available for a new transmission and if the uplink resources can accommodate a BFR MAC CE plus its sub-header as a result of logical channel prioritization (LCP), then a multiplexing and assembly procedure is instructed to generate the BFR MAC CE;
If the uplink resources are available for a new transmission and if the uplink resource can accommodate a truncated BFR MAC CE plus its sub-header as a result of logical channel prioritization (LCP), then the multiplexing and assembly procedure is instructed to generate the truncated BFR MAC CE;
Otherwise, a scheduling request (SR) is triggered for each secondary cell for which the BFR has been triggered and not cancelled, and for which the evaluation of its candidate beams has been completed according to the requirements.

Therefore, the beam failure information of the secondary cell may be carried by the BFR MAC CE or the truncated BFR MAC CE and transmitted by the terminal equipment to the network device.

It should be noted that, the above introduction to the background is merely for the convenience of clear and complete description of the technical solution of the present application, and for the convenience of understanding of persons skilled in the art. It cannot be regarded that the above technical solution is commonly known to persons skilled in the art just because that the solution has been set forth in the background of the present application.

### SUMMARY

However, the inventor has found that in multiple transmission reception points (TRP) operation, if only part of the beams fails, the terminal equipment may not trigger beam failure detection; in addition, if the beam failure detection is not distinguished between a cell level or a TRP level, resources may be wasted.

To address at least one of the above problems, embodiments of the present application provide a method and an apparatus for detecting beam failure.

According to an aspect of the embodiments of the present application, there is provided with an apparatus for detecting beam failure, including:
a receiving unit configured to receive a beam failure instance indication by a medium access control entity;
a counting unit configured to increment a TRP-specific beam failure indication count by 1; and
a processing unit configured to, in a case where the TRP-specific beam failure indication count is greater than or equal to a TRP-specific beam failure instance maximum count, determine that a beam failure occurs in a transmission reception point or beam failure recovery (BFR) of the transmission reception point is triggered or a beam failure indication of the transmission reception point is triggered.

According to another aspect of the embodiments of the present application, there is provided with a method for detecting beam failure, including:
receiving a beam failure instance indication by a medium access control (MAC) entity of a terminal equipment;
incrementing a transmission reception point (TRP)-specific beam failure indication count by 1; and
in a case where the TRP-specific beam failure indication count is greater than or equal to a TRP-specific beam failure instance maximum count, determining that a beam failure occurs in a transmission reception point or beam failure recovery (BFR) of the transmission reception point is triggered or a beam failure indication of the transmission reception point is triggered.

According to another aspect of the embodiments of the present application, there is provided with a communication system, including:
a terminal equipment, configured to receive a beam failure instance indication by a medium access control (MAC) entity, increment a transmission reception point (TRP)-specific beam failure indication count by 1, and in a case where the TRP-specific beam failure indication count is greater than or equal to a TRP-specific beam failure instance maximum count, determine that a beam failure occurs in a transmission reception point or beam failure recovery (BFR) of the transmission reception point is triggered or a beam failure indication of the transmission reception point is triggered.

One of the advantageous effects of the embodiments of the present application is that, the MAC entity of the terminal equipment receives a beam failure instance indication, increments a transmission reception point (TRP)-specific beam failure indication count by 1, and in a case where the TRP-specific beam failure indication count is greater than or equal to a TRP-specific beam failure instance maximum count, determines that a beam failure occurs in a transmission reception point or beam failure recovery (BFR) of the transmission reception point is triggered or a beam failure indication of the transmission reception point is triggered. Thus, not only beam failure detection at the TRP level can be triggered when only part of the beams fails, but also beam failure detection at the cell level or the TRP level can be distinguished, thereby avoiding resource waste.

With reference to the Description and drawings below, a specific embodiment of the present application is disclosed in detail, which specifies the manner in which the principle of the present application can be adopted. It should be understood that, the scope of the embodiment of the present application is not limited. Within the scope of the spirit and clause of the appended claims, the embodiment of the present application includes many variations, modifications and equivalents.

The features described and/or shown for one embodiment can be used in one or more other embodiments in the same or similar manner, can be combined with the features in other embodiments or replace the features in other embodiments.

It should be emphasized that, the term “include/contain” refers to, when being used in the text, existence of features, parts, steps or assemblies, without exclusion of existence or attachment of one or more other features, parts, steps or assemblies.

### BRIEF DESCRIPTION OF DRAWINGS

Elements and features described in one drawing or one embodiment of embodiments of the present application may be combined with elements and features illustrated in one or more other drawings or embodiments. Furthermore, in the drawings, like reference numerals refer to corresponding parts in the several drawings and may be used to indicate corresponding parts used in more than one embodiment.

FIG. 1 is a schematic diagram of a communication system according to an embodiment of the present application;

FIG. 2 is a schematic diagram of a BFR MAC CE or a truncated BFR MAC CE in a first format;

FIG. 3 is a schematic diagram of a BFR MAC CE or a truncated BFR MAC CE in a second format;

FIG. 4 is a schematic diagram of a multi-TRP scenario according to an embodiment of the present application;

FIG. 5 is a schematic diagram of a method for detecting beam failure according to an embodiment of the present application;

FIG. 6 is a schematic diagram of a BFD or BFR according to an embodiment of the present application;

FIG. 7 is another schematic diagram of a method for detecting beam failure according to an embodiment of the present application;

FIG. 8A is another schematic diagram of a method for detecting beam failure according to an embodiment of the present application;

FIG. 8B is another schematic diagram of a method for detecting beam failure according to an embodiment of the present application;

FIG. 9 is another schematic diagram of a method for detecting beam failure according to an embodiment of the present application;

FIG. 10 is another schematic diagram of a method for detecting beam failure according to an embodiment of the present application;

FIG. 11A is another schematic diagram of a method for detecting beam failure according to an embodiment of the present application;

FIG. 11B is another schematic diagram of a method for detecting beam failure according to an embodiment of the present application;

FIG. 12 is a schematic diagram of an apparatus for detecting beam failure according to an embodiment of the present application;

FIG. 13 is a schematic diagram of a network device according to an embodiment of the present application;

FIG. 14 is a schematic diagram of a terminal device according to an embodiment of the present application.

### DESCRIPTION OF EMBODIMENTS

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to an equipment in a communication system that accesses a terminal equipment to the communication network and provides services for the terminal equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.), IAB (Integrated Access and Backhaul) node or IAB-DU or IAB-donor. The term “base station” may include some or all of its functions, and each base station may provide communication coverage for a specific geographical area. And a term “cell” may refer to a base station and/or its coverage area, which may be expressed as a serving cell, and may be a macro cell or a pico cell, depending on a context of the term.

In the embodiments of this disclosure, the term “user equipment (UE)” or “terminal equipment (TE) or terminal device” refers to, for example, equipment accessing to a communication network and receiving network services via a network device. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station, and may include one or more network devices described above. The term “user side” or “terminal side” or “terminal equipment side” refers to a side of a user or a terminal, which may be a UE, and may include one or more terminal equipments described above. Herein, a “device” may refer to both a network device and a terminal device unless otherwise specified.

Scenarios in the embodiments of this disclosure shall be described below by way of examples; however, this disclosure is not limited thereto.

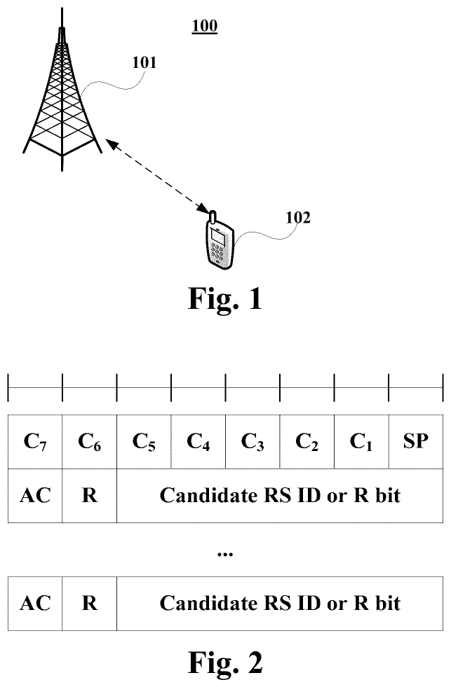

FIG. 1 is a schematic diagram of a communication system according to an embodiment of the present application, schematically illustrating a case where a terminal device and a network device are taken as examples. As shown in FIG. 1, the communication system 100 may include a network device 101 and a terminal device 102. For the sake of simplicity, FIG. 1 gives illustration by taking only one terminal device and one network device as examples, but the embodiment of the present application is not limited thereto, and there may be a plurality of terminal devices, for example.

In an embodiment of the present application, existing services or services that can be implemented in the future can be transmitted between the network device 101 and the terminal device 102. For example, these traffics may include, but are not limited to, enhanced Mobile Broadband (eMBB), massive Machine Type Communication (mMTC) and Ultra-Reliable and Low-Latency Communication (URLLC), etc.

In the beam failure detection (BFD) procedure of Rel-15/16, the MAC entity of the medium access control (MAC) layer of the terminal equipment detects a beam failure by counting beam failure instance indication from lower layers (e.g. a physical layer) to the MAC entity.

For example, the beam failure detection procedure uses the UE variable BFI_COUNTER, which is a counter for the beam failure instance indication, initially set to 0, with one BFI_COUNTER per serving cell. For each serving cell configured with beam failure detection, the MAC entity will execute the following operation:

If beam failure instance indication has been received from the lower layers, a beam FailureDetectionTimer is started or restarted; and the terminal equipment variable BFI_COUNTER is incremented by 1; in a case that BFI_COUNTER is greater than or equal to a beamFailureInstanceMaxCount: if the serving cell is a secondary cell (SCell), one beam failure recovery (BFR) of the serving cell is triggered, otherwise, a random access procedure is initiated on the special cell (SpCell). The BFI_COUNTER is set to 0 if the beamFailure DetectionTimer expires, or if beamFailureDetectionTimer, beamFailureInstance MaxCount, or any of reference signals for beam failure detection is reconfigured by upper layers associated with this serving cell.

In the beam failure recovery procedure, beam failure information of a secondary cell may be carried by a BFR MAC CE or a truncated BFR MAC CE, and transmitted by the terminal equipment to the network device.

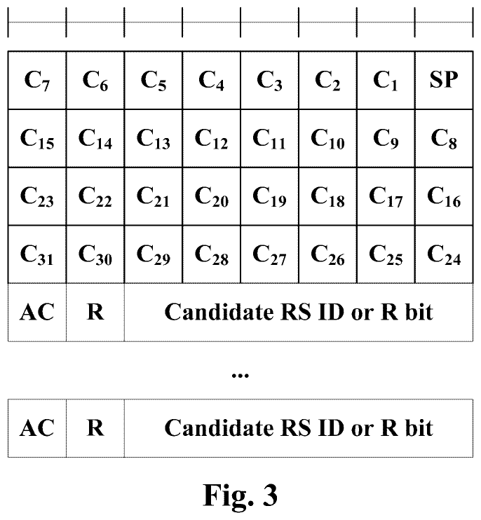

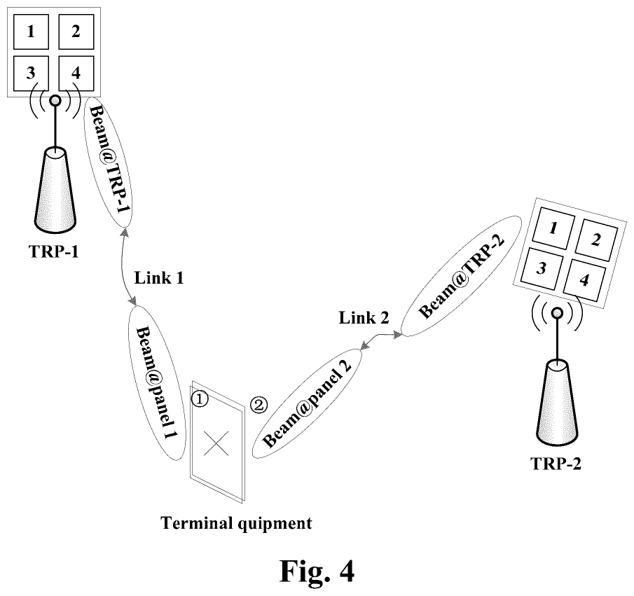

FIG. 2 is a schematic diagram of a BFR MAC CE or a truncated BFR MAC CE in a first format (called Format 1). FIG. 3 is a schematic diagram of a BFR MAC CE or a truncated BFR MAC CE in a second format (called Format 2).

In particular, for the BFR MAC CE, for example, if the highest ServCellIndex of the MAC entity's secondary cell for which beam failure is detected and the evaluation of the candidate beams according to the requirement has been completed is less than 8, then Format 1 in FIG. 2 is used; otherwise Format 2 in FIG. 3 is used.

For the truncated BFR MAC CE, if the highest ServCellIndex of the MAC entity's secondary cell for which beam failure is detected and the evaluation of the candidate beams according to the requirement has been completed is less than 8, or the special cell detects a beam failure and this special cell will be included in a truncated BFR MAC CE, and the UL-SCH resource cannot accommodate the Truncated BFR MAC CE of Format 2 in FIG. 3 plus its sub-header as a result of LCP, then Format 1 of FIG. 2 is used; otherwise Format 2 in FIG. 3 is used.

For example, the field definitions for Format 1 and Format 2 are as follows:
For the BFR MAC CE, the Ci field indicates beam failure detection of the secondary cell with ServCellIndex i, whether evaluation of the candidate beam is completed and presence of an octet containing an AC field, the AC field indicates the presence of a Candidate RS ID field in this octet, and the Candidate RS ID field is set to the index of SSB or CSI-RS.

The Ci field set to 1 indicates that beam failure is detected, the evaluation of the candidate beams according to requirements has been completed, and the octet containing the AC field is present for the secondary cell with ServCellIndex i. The Ci field set to 0 indicates that the beam failure is not detected, or the beam failure is detected but the evaluation of the candidate beams according to requirements has not been completed, and the octet containing the AC field is not present for the secondary cell with ServCellIndex i. The octets containing the AC field are present in an ascending order based on ServCellIndex.

For the truncated BFR MAC CE, the Ci field indicates beam failure detection of the secondary cell with ServCellIndex i, whether evaluation of the candidate beam is completed and presence of an octet containing an AC field, the AC field indicates the presence of a Candidate RS ID field in this octet, and the Candidate RS ID field is set to the index of SSB or CSI-RS.

The Ci field set to 1 indicates that beam failure is detected, the evaluation of the candidate beams according to requirements has been completed, and the oct containing the AC field is present for the secondary cell with ServCellIndex i. The Ci field set to 0 indicates that beam failure is not detected, or beam failure is detected but the evaluation of the candidate beams according to requirements has not been completed, and the octet containing the AC field is not present for the secondary cell with ServCellIndex i. If present, the octets containing the AC field are included in ascending order based on ServCellIndex. The number of the octets containing the AC field may be 0, while not exceeding the size of the available grant.

The (Truncated) BFR MAC CE is schematically described above, and the related scenarios of the embodiments of the present application are described below. In the embodiments of the present application, the beam may be replaced by a reference signal (RS), and may be represented by SSB or CSI-RS, for example.

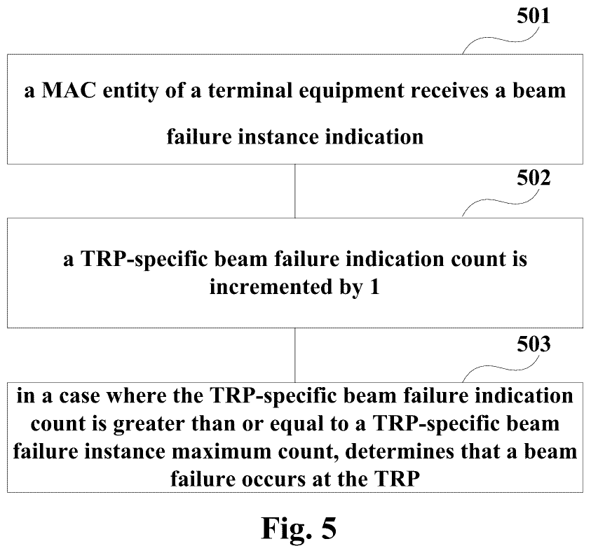

FIG. 4 is a schematic diagram of a multi-TRP scenario according to an embodiment of the present application. The TRP may be part of a network device (e.g., gNB) that receives signals from the terminal equipment, or part of a network device (gNB) that transmits signals to the terminal equipment. In addition, the TRP may also represent a set of downlink control information (DCI) or a set of reference signals, etc.

As shown in FIG. 4, in the scenario of multi-TRP operation, the terminal equipment may have a panel 1 (panel-1) and a panel 2 (panel-2); one serving cell may schedule the terminal equipment from 2 TRPs, provide better physical downlink shared channel (PDSCH) coverage, reliability, and/or data rate.

For the multi-TRP operation, there may be two different modes of operation: single DCI and multiple DCI. For the two modes, control of the uplink and downlink operations is performed by the physical layer and medium access control (MAC). In the single DCI mode, the terminal equipment is scheduled by two TRPs through the same DCI; and in the multi-DCI mode, the terminal equipment is scheduled by a separate DCI of each TRP.

In the multi-TRP operation, according to the mechanism of Rel-15/16 beam failure detection and beam failure recovery, when a beam between a single TRP and the terminal equipment is blocked while a beam between another TRP and the terminal equipment operates, the physical layer does not indicate a beam failure instance to the MAC layer and does not trigger the beam failure detection procedure of the MAC layer. In addition, if the beam failure detection is not distinguished between the cell level and the TRP level, resources may be wasted.

For example, if a failure occurs on only one TRP in a cell, the physical layer indicates a beam failure instance to the MAC layer; the terminal equipment and the network device believe that a cell-level beam failure has occurred, a cell handover procedure may be performed, another TRP on the cell where failure has not occurred is not fully utilized and thus resource utilization is low.

For another example, if a beam failure is detected on one of the TRPs of a special cell, the terminal equipment may not trigger the BFR but may trigger random access (RA). In this case, the random access is unnecessary, resulting in waste of random access resources and longer service interruption.

In response to the above problem, the embodiments of the present application are further described below. The embodiments of the present application are described from the MAC layer of the terminal equipment and implemented by the MAC entity, wherein the MAC entity includes a beam failure detection procedure, a beam failure recovery procedure, and a multiplexing and assembly entity (hereinafter also referred to as a multiplexing and assembly procedure), etc. The lower layers of the embodiments of the present application are, for example, physical layers, antenna units, measurement procedures, etc. For specific concepts and definitions of each layer and each entity, reference may be made to related technologies, and detailed description is omitted in embodiments of the present application.

In the embodiments of the present application, cell-specific may be understood as cell-level or all beam, with cell as granularity, and TRP-specific may be understood as TRP-level or part of the beams, with TRP as granularity. The cell-specific MAC CE may be a BFR MAC CE of Rel-15/Rel-16 or a truncated BFR MAC CE of Rel-15/Rel-16, etc. The term “detected beam failure” may be interchanged with “triggered beam failure recovery” or “triggered beam failure indication”.

### Embodiments of the First Aspect

An embodiment of the present application provides a method for detecting beam failure, which is described from a terminal equipment.

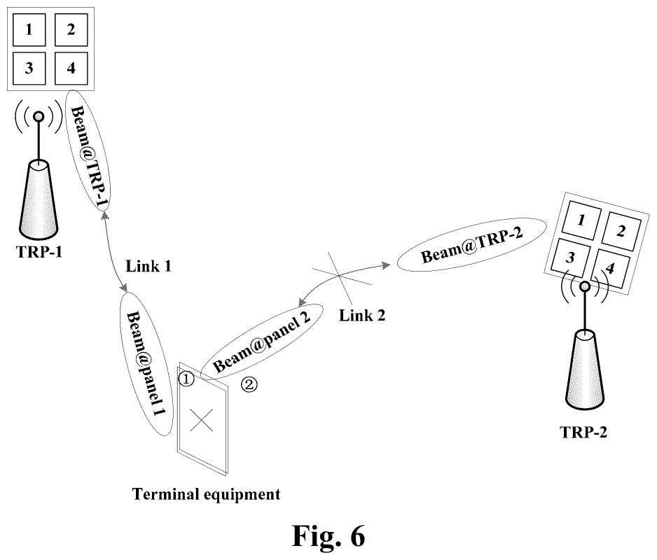

FIG. 5 is a schematic diagram of a method for detecting beam failure according to an embodiment of the present application, as shown in FIG. 5, the method including:
501, a medium access control (MAC) entity of a terminal equipment receives a beam failure instance indication;
502, a transmission reception point (TRP)-specific beam failure indication count is incremented by 1; and
503, in a case where the TRP-specific beam failure indication count is greater than or equal to a TRP-specific beam failure instance maximum count, determines that a beam failure occurs in a transmission reception point or beam failure recovery (BFR) of the transmission reception point is triggered or a beam failure indication of the transmission reception point is triggered.

It should be noted that FIG. 5 only schematically illustrates the embodiment of the present application, but the present application is not limited thereto. For example, the execution order between the operations may be appropriately adjusted, and some other operations may be added or some of the operations may be reduced. And appropriate variants may be made by those skilled in the art according to the above contents, which are not limited to the description of FIG. 5 described above.

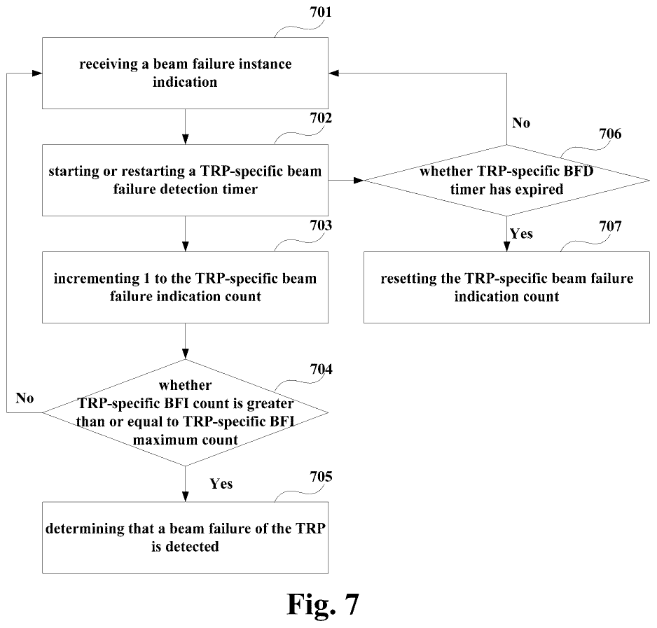

FIG. 6 is a schematic diagram of beam failure detection (BFD) or beam failure recovery (BFR) according to an embodiment of the present application. As shown in FIG. 6, the network device provides service for the terminal equipment by using TRP-1 and TRP-2. The link 1 (link-1) between the TRP-1 and the terminal equipment operates normally, but the link 2 (link-2) between the TRP-2 and the terminal equipment is blocked.

In embodiments of the present application, the terminal equipment may configure the BFD of the TRP level or trigger the BFR of the TRP level independently of the BFD procedure of the cell level. Thus, not only beam failure detection at the TRP level can be triggered when only part of the beams fails, but also beam failure detection at the cell level or the TRP level can be distinguished, thereby avoiding resource waste.

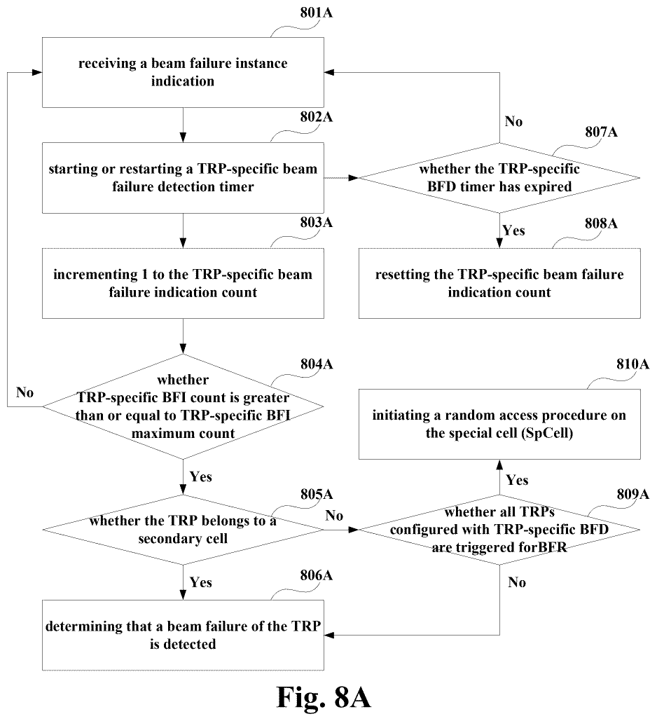

FIG. 7 is another schematic diagram of a method for detecting beam failure according to an embodiment of the present application, schematically illustrating an operation of an MAC entity of a terminal equipment for a TRP configured with beam failure detection. As shown in FIG. 7, the operation of the MAC entity includes:
701, receiving a beam failure instance indication from a lower layer;
702, starting or restarting a transmission reception point (TRP)-specific beam failure detection timer (e.g., beamFailure DetectionTimer-perTRP);
703, incrementing 1 to the TRP-specific beam failure indication count (e.g., BFI_COUNTER-per TRP) associated with the TRP-specific beam failure detection timer (e.g., beamFailureDetectionTimer-per TRP);
704, determining whether the TRP-specific beam failure indication count (e.g., BFI_COUNTER-perTRP) is greater than or equal to the TRP-specific beam failure instance maximum count (e.g., beamFailureInstanceMaxCount-per TRP); and
705, in a case where the TRP-specific beam failure indication count (e.g., BFI_COUNTER-perTRP) is greater than or equal to the TRP-specific beam failure instance maximum count (e.g., beamFailureInstanceMaxCount-perTRP), determining that a beam failure of the TRP is detected or a beam failure recovery (BFR) of the TRP is triggered or a beam failure indication of the TRP is triggered.

As shown in FIG. 7, the operation of the MAC entity further includes:
706, determining whether the TRP-specific beam failure detection timer (e.g., beamFailure DetectionTimer-perTRP) has expired; and
707, resetting the TRP-specific beam failure indication count (e.g., BFI_COUNTER-perTRP) or setting the TRP-specific beam failure indication count (e.g., BFI_COUNTER-perTRP) to 0 in the case where the TRP-specific beam failure detection timer has expired.

In some embodiments, the TRP-specific beam failure indication count (e.g., BFI_COUNTER-perTRP) is also reset or set to 0 in one or any combination of the following cases:
deactivation of the secondary cell;
the TRP-specific beam failure detection timer, the TRP-specific beam failure instance maximum count, a reference signal for detecting that a beam failure occurs in a transmission reception point or beam failure recovery (BFR) of the transmission reception point is triggered or a beam failure indication of the transmission reception point is triggered, are reconfigured by the upper layer;
MAC reset;
the TRP on a cell is reconfigured, including a control resource pool associated a control resource is reconfigured, or the TRP index is reconfigured.

It should be noted that FIG. 7 only schematically illustrates the embodiment of the present application, but the present application is not limited thereto. For example, the execution order between the operations may be appropriately adjusted, and some other operations may be added or some of the operations may be reduced. And appropriate variants may be made by those skilled in the art according to the above contents, which are not limited to the description of FIG. 7 described above.

In some embodiments, the MAC entity of the terminal equipment instructs the multiplexing and assembly entity to generate a TRP-specific beam failure recovery MAC CE or a TRP-specific beam failure MAC CE. For the content of generating the MAC CE, reference may also be made to an embodiment of the third aspect described later.

In some embodiments, the MAC entity of the terminal equipment determines whether the evaluation of the candidate beam is completed when the candidate beam is configured.

In some embodiment, if the beam failure recovery procedure determines that at least one beam failure recovery has been triggered and not cancelled, or a beam failure is detected, or at least one beam failure indication is triggered and not cancelled, and if a candidate beam list is configured and evaluation of at least one reference signal in the candidate beam list has been completed, the MAC entity of the terminal equipment instructs the multiplexing and assemble entity to generate the TRP-specific beam failure recovery MAC CE or the TRP-specific beam failure MAC CE.

For example:
if the beam failure recovery procedure determines that at least one beam failure recovery has been triggered and not cancelled, or a beam failure is detected, or at least one beam failure indication is triggered and not cancelled, if a candidate beam is configured and evaluation of the candidate beam has been completed,
If the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
Otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
Otherwise, a scheduling request (SR) for the TRP-specific beam failure recovery or the TRP-specific beam failure is triggered for each TRP that has triggered a BFR and has not been cancelled.

In some embodiments, if the beam failure recovery procedure determines that at least one beam failure recovery has been triggered and not cancelled, or a beam failure is detected, or at least one beam failure indication is triggered and not cancelled, and if a candidate beam list is not configured, the MAC entity of the terminal equipment does not determine whether the evaluation of the candidate beam is completed.

For example:
if the beam failure recovery procedure determines that at least one beam failure recovery has been triggered and not cancelled, or a beam failure is detected, or at least one beam failure indication is triggered and not cancelled,
if a candidate beam is configured and evaluation of the candidate beam has been completed, or a candidate beam is not configured,
If the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
Otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
Otherwise, a scheduling request (SR) for the TRP-specific beam failure recovery or the TRP-specific beam failure is triggered for each TRP that has triggered a BFR and has not been cancelled.

In some embodiments, the TRP is configured with beam failure recovery or with beam failure recovery parameters, and/or is configured with beam failure detection or with beam failure detection parameters; for each TRP configured with beam failure recovery or with beam failure recovery parameters, and/or configured with beam failure detection or with beam failure detection parameters, the MAC entity will determine whether to instruct generation of an MAC CE or trigger a scheduling request (SR).

For example, for each TRP configured with beam failure recovery or with beam failure recovery parameters, and/or configured with beam failure detection or with beam failure detection parameters, the MAC entity executes the following operations:
if the beam failure recovery procedure determines that at least one beam failure recovery has been triggered and not cancelled, or a beam failure is detected, or at least one beam failure indication is triggered and not cancelled, and evaluation of the candidate beam has been completed,
If the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
Otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
Otherwise, a scheduling request (SR) for the beam failure recovery or the beam failure is triggered for each TRP that has triggered a BFR and has not been cancelled.

In some embodiments, the TRP is configured with beam failure recovery or with beam failure recovery parameters, and/or is configured with beam failure detection or with beam failure detection parameters; for each TRP configured with beam failure recovery or with beam failure recovery parameters, and/or configured with beam failure detection or with beam failure detection parameters, the MAC entity will perform beam failure detection to trigger the BFR.

For example, for a TRP configured with beam failure recovery or beam failure recovery parameters, the MAC entity receives a beam failure instance indication, starts or restarts a transmission reception point (TRP)-specific beam failure detection timer, increments a transmission reception point (TRP)-specific beam failure indication count by 1, and in a case where the TRP-specific beam failure indication count is greater than or equal to a TRP-specific beam failure instance maximum count, determines that a beam failure occurs in a transmission reception point or beam failure recovery (BFR) of the transmission reception point is triggered or a beam failure indication of the transmission reception point is triggered.

In some embodiments, the MAC entity of the terminal equipment determines that the evaluation of the candidate beam has been completed if the candidate beam is not configured in the case where at least one beam failure recovery is triggered.

In some embodiments, the physical layer of the terminal equipment, upon receiving the higher layer request, determines that the evaluation of the candidate beam has been completed in a case where the candidate beam is not configured.

In some embodiments, in a case where a reference signal for beam failure detection is configured, a candidate reference signal is configured. For example, if a reference signal for beam failure detection is configured, a candidate reference signal should be configured.

The TRP-specific beam failure recovery MAC CE or the TRP-specific beam failure MAC CE is schematically described above, and the Fallback mechanism of the embodiment of the present application is described below.

In some embodiments, some or all of the serving cells in the MAC entity of the terminal equipment are configured with TRP-specific beam failure detection, and/or, a special cell in the MAC entity of the terminal equipment is configured with the TRP-specific beam failure detection.

For example, for an MAC entity, the Fallback mechanism is supported if beam failure detection at the TRP level is configured while beam failure detection at the cell level is not configured. Here, the “beam failure detection at the cell level is not configured” includes that all the serving cells configured in the MAC entity are not configured with Rel-15/16 beam failure detection, or the special cell in this MAC entity is not configured with Rel-15/16 beam failure detection.

Specifically, for example, all the serving cells configured in the MAC entity are not configured with beam failure detection, or are not configured with RadioLinkMonitoringConfig, or parameters of beam failure detection are not configured/not included in RadioLink MonitoringConfig. Alternatively, the special cell in the MAC entity is not configured with beam failure detection, or is not configured with RadioLink MonitoringConfig, or parameters of beam failure detection are not configured/not included in RadioLinkMonitoringConfig.

For another example, for an MAC entity, the Fallback mechanism is supported if beam failure recovery at the TRP level is configured while beam failure recovery at the cell level is not configured. Here, the “beam failure recovery at the cell level is not configured” includes that all the serving cells configured in the MAC entity are not configured with Rel-15/16 beam failure recovery, or the special cell in this MAC entity is not configured with Rel-15/16 beam failure recovery.

Specifically, for example, all the serving cells configured in the MAC entity are not configured with beam failure recovery, or are not configured with BeamFailureRecoverySCell Config, or parameters (e.g., candidateBeamRSSCellList) of the secondary cell beam failure recovery procedure is not configured/not included in BeamFailureRecoverySCellConfig. Alternatively, the special cell in the MAC entity is not configured with beam failure recovery, or is not configured with BeamFailureRecoveryConfig, or parameters (e.g., candidateBeamRS List) of the secondary cell beam failure recovery procedure is not configured/not included in BeamFailureRecoveryConfig.

In some embodiments, the MAC entity of the terminal equipment determines whether the transmission reception point belongs to a secondary cell, and in a case where the transmission reception point belongs to a secondary cell, determines that a beam failure occurs in the transmission reception point or beam failure recovery of the transmission reception point is triggered or a beam failure indication of the transmission reception point is triggered.

In some embodiments, the MAC entity of the terminal equipment determines whether all TRPs configured with TRP-specific beam failure detection are triggered for beam failure recovery; in the case where all TRPs configured with TRP-specific beam failure detection are triggered for beam failure recovery, the MAC entity of the terminal equipment initiates a random access procedure in the special cell.

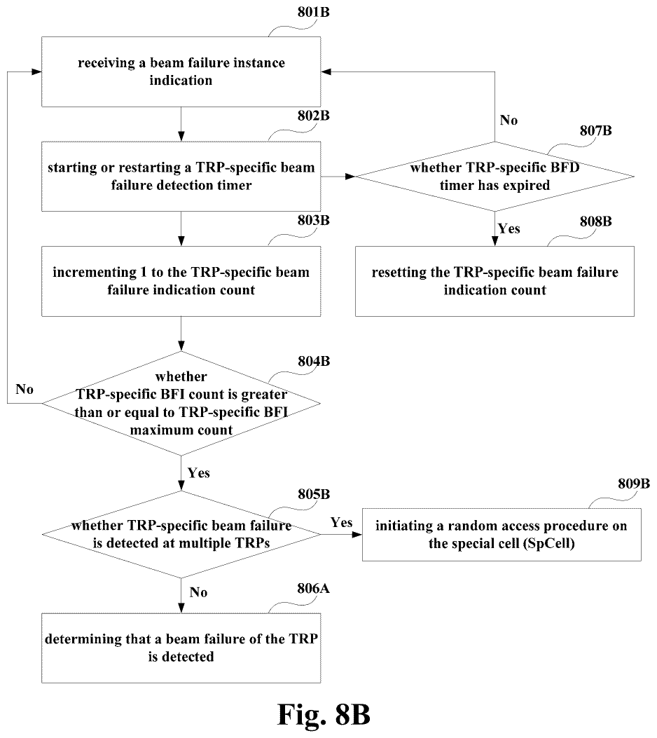

FIG. 8A is another schematic diagram of a method for detecting beam failure according to an embodiment of the present application, schematically illustrating an operation of an MAC entity of a terminal equipment for a TRP configured with beam failure detection. As shown in FIG. 8A, the operation of the MAC entity includes:
801A, receiving a beam failure instance indication from a lower layer;
802A, starting or restarting a transmission reception point (TRP)-specific beam failure detection timer (e.g., beamFailure DetectionTimer-perTRP);
803A, incrementing 1 to the TRP-specific beam failure indication count (e.g., BFI_COUNTER-perTRP) associated with the TRP-specific beam failure detection timer (e.g., beamFailure DetectionTimer-per TRP);
804A, determining whether the TRP-specific beam failure indication count (e.g., BFI_COUNTER-perTRP) is greater than or equal to the TRP-specific beam failure instance maximum count (e.g., beamFailureInstanceMaxCount-perTRP); and performing 805A if the TRP-specific beam failure indication count (e.g., BFI_COUNTER-perTRP) is greater than or equal to the TRP-specific beam failure instance maximum count (e.g., beamFailureInstanceMaxCount-per TRP);
805A, determining whether the TRP belongs to the secondary cell (SCell); and performing 806A if the TRP belongs to the secondary cell (SCell) and performing 809A if the TRP does not belong to the secondary cell (SCell);
806A, determining that a beam failure of the TRP is detected or a beam failure recovery (BFR) of the TRP is triggered or a beam failure indication of the TRP is triggered.

As shown in FIG. 8A, the operation of the MAC entity further includes:
807A, determining whether the TRP-specific beam failure detection timer (e.g., beamFailure DetectionTimer-perTRP) has expired; and performing 808A in the case where the TRP-specific beam failure detection timer has expired;
808A, resetting the TRP-specific beam failure indication count (e.g., BFI_COUNTER-perTRP) or setting the TRP-specific beam failure indication count (e.g., BFI_COUNTER-per TRP) to 0.

As shown in FIG. 8A, the operation of the MAC entity further includes:
809A, determining whether all TRPs configured with TRP-specific beam failure detection are triggered for beam failure recovery (or determining whether other TRPs of the serving cells that are configured with TRP-specific beam failure detection are all triggered for beam failure recovery); performing 810A in the case where all TRPs configured with TRP-specific beam failure detection are triggered for beam failure recovery (or other TRPs of the serving cells that are configured with TRP-specific beam failure detection are all triggered for beam failure recovery), otherwise performing 806A;
810A, initiating a random access procedure on the special cell (SpCell).

It should be noted that FIG. 8A only schematically illustrates the embodiment of the present application, but the present application is not limited thereto. For example, the execution order between the operations may be appropriately adjusted, and some other operations may be added or some of the operations may be reduced. Those skilled in the art may make appropriate modifications according to the above content, which are not limited to the description of FIG. 8A described above.

As shown in FIG. 8A, for example for a certain TRP, if the UE variable (e.g., BFI_COUNTER-perTRP) of the TRP-specific/per TRP associated with the beam failure indication counter is greater than or equal to the beam failure instance maximum count value,

If the TRP belong to a secondary cell, or if the TRP belongs to a special cell and another TRP of this cell has not triggered a BFR, a BFR is triggered for this TRP.

Otherwise, a random access procedure is initiated on this special cell.

In some embodiments, all of the serving cells in the MAC entity of the terminal equipment do not configured with cell-specific beam failure detection, or, a special cell in the MAC entity of the terminal equipment does not configured with the cell-specific beam failure detection. In a case where TRP-specific beam failure is detected or TRP-specific beam failure recovery is triggered at multiple TRPs, the MAC entity of the terminal equipment initiates a random access procedure on the special cell.

For another example, the Fallback mechanism includes initiating a random access procedure on a special cell when the TRP-specific beam failure is detected or the TRP-specific beam failure recovery is triggered at multiple TRPs. Here, the multiple TRPs include all TRPs configured with TRP-specific beam detection of all serving cells configured in a MAC entity, or all TRPs configured with TRP-specific beam detection of a special cell in a MAC entity.

In some embodiments, the multiple TRPs include all TRPs configured with TRP-specific beam failure detection of all serving cells in a MAC entity, or all TRPs configured with TRP-specific beam failure detection of a special cell in a MAC entity.

FIG. 8B is another schematic diagram of a method for detecting beam failure according to an embodiment of the present application, schematically illustrating an operation of an MAC entity of a terminal equipment for a TRP configured with beam failure detection. As shown in FIG. 8B, the operation of the MAC entity includes:
801B, receiving a beam failure instance indication from a lower layer;
802B, starting or restarting a transmission reception point (TRP)-specific beam failure detection timer (e.g., beamFailure DetectionTimer-perTRP);
803B, incrementing 1 to the TRP-specific beam failure indication count (e.g., BFI_COUNTER-perTRP) associated with the TRP-specific beam failure detection timer (e.g., beamFailureDetectionTimer-per TRP);
804B, determining whether the TRP-specific beam failure indication count (e.g., BFI_COUNTER-perTRP) is greater than or equal to the TRP-specific beam failure instance maximum count (e.g., beamFailureInstanceMaxCount-perTRP); and performing 805B if the TRP-specific beam failure indication count (e.g., BFI_COUNTER-perTRP) is greater than or equal to the TRP-specific beam failure instance maximum count (e.g., beamFailure InstanceMaxCount-per TRP);
805B, determining whether the TRP-specific beam failure is detected or TRP-specific BFR is triggered at multiple TRPs; and performing 806B if not, and performing 809B if yes;

The multiple TRPs include all TRPs configured with TRP-specific beam failure detection of all serving cells in the MAC entity, or all TRPs configured with TRP-specific beam failure detection of a special cell in the MAC entity.
806B, determining that a beam failure of the TRP is detected or a beam failure recovery (BFR) of the TRP is triggered or a beam failure indication of the TRP is triggered.

As shown in FIG. 8B, the operation of the MAC entity further includes:
807B, determining whether the TRP-specific beam failure detection timer (e.g., beamFailureDetectionTimer-perTRP) has expired; and performing 808B in the case where the TRP-specific beam failure detection timer has expired;
808B, resetting the TRP-specific beam failure indication count (e.g., BFI_COUNTER-per TRP) or setting the TRP-specific beam failure indication count (e.g., BFI_COUNTER-per TRP) to 0.

As shown in FIG. 8B, the operation of the MAC entity further includes:
809B, initiating a random access procedure on the special cell (SpCell).

It should be noted that FIG. 8B only schematically illustrates the embodiment of the present application, but the present application is not limited thereto. For example, the execution order between the operations may be appropriately adjusted, and some other operations may be added or some of the operations may be reduced. And appropriate variants may be made by those skilled in the art according to the above contents, which are not limited to the description of FIG. 8B described above.

Thus, a beam failure is detected on one of the TRPs of a special cell, the terminal equipment may trigger the BFR; and random access (RA) is triggered only if beam failure is detected on all TRPs (configured with the TRP-specific beam failure detection) of the special cell. Unnecessary random access can be avoided, thereby avoiding waste of random access resources and longer service interruption.

For another example, as long as a TRP-specific BFR is configured, a cell-specific BFD on a specific cell should be configured, or a cell-specific BFD on a belonging cell should be configured or a cell-specific BFD on at least one cell should be configured, this may eliminate the need for the fallback mechanism described above.

In some embodiments, the terminal equipment may perform one or any combination of the following:
in the case where the terminal equipment transmits an MAC PDU and the MAC PDU includes a TRP-specific beam failure recovery MAC CE or a TRP-specific beam failure MAC CE, the terminal equipment cancels all of the beam failure recovery triggered for the TRPs before assembly of the MAC PDU;
in the case where the terminal equipment transmits an MAC PDU, and the MAC PDU includes a beam failure recovery MAC CE or a truncated beam failure recovery MAC CE, and the MAC CE includes beam failure information of a cell, the MAC entity of the terminal equipment cancels all of the beam failure recovery triggered for all TRPs included in the cell before assembly of the MAC PDU;
if a PDCCH addressed by the C-RNTI indicates receipt of uplink grant for a new transmission of a HARQ process for transmission including a TRP-specific beam failure recovery MAC CE or a TRP-specific beam failure MAC CE, the MAC entity of the terminal equipment cancels all beam failure recovery triggered for the TRP;
if a PDCCH addressed by the C-RNTI indicates receipt of uplink grant for a new transmission of a HARQ process for transmission including a beam failure recovery MAC CE or a truncated beam failure recovery MAC CE of beam failure information of a cell, the MAC entity of the terminal equipment cancels all beam failure recovery triggered for all TRPs included in the cell.

The Fallback mechanism and the cancellation of the BFR are schematically described above, and the SR is described below.

In some embodiments, the terminal equipment triggers a scheduling request (SR) for the TRP-specific beam failure recovery or the TRP-specific beam failure, for a TRP that has triggered a BFR and has not been cancelled.

In some embodiments, the scheduling request configures a SR ID or a set of SR IDs.

For example, SchedulingRequestId=(0 . . . 7); the present application is not limited to this.

In some embodiments, the configuration value of the TRP-specific beam failure recovery SR ID (e.g., SchedulingRequestId) is the same as the configuration value of the cell-specific beam failure recovery SR ID, or the configuration value of the TRP-specific beam failure recovery SR ID is different from configuration value of the cell-specific beam failure recovery SR ID.

The configuration of the SR may be included in IE MAC-CellGroupConfig or in IE CellGroupConfig.

For example, an SR ID is configured and included in IE MAC-CellGroupConfig. As shown in Tables 1 and 2 below:

TABLE 1
The IE MAC-CellGroupConfig is used to configure MAC parameters for a cell group, including DRX.
MAC-CellGroupConfig information element

-- ASN1START
-- TAG-MAC-CELLGROUPCONFIG-START

| | |
|---|---|
| MAC-CellGroupConfig ::= | SEQUENCE { |

| | |
|---|---|
| drx-Config | SetupRelease { DRX-Config } |

OPTIONAL, -- Need M

| | |
|---|---|
| schedulingRequestConfig | SchedulingRequestConfig |

OPTIONAL, -- Need M

| | |
|---|---|
| bsr-Config | BSR-Config |

OPTIONAL, -- Need M

| | |
|---|---|
| tag-Config | TAG-Config |

OPTIONAL, -- Need M

| | |
|---|---|
| phr-Config | SetupRelease { PHR-Config } |

OPTIONAL, -- Need M

| skipUplinkTxDynamic | BOOLEAN, |
|---|---|
| . . . , | |
| [[ | |
| csi-Mask | BOOLEAN |

OPTIONAL, -- Need M

dataInactivityTimer SetupRelease { DataInactivityTimer } OPTIONAL --

Cond MCG-Only

| ]], | |
|---|---|
| [[ | |
| usePreBSR-r16 | ENUMERATED { true} |

OPTIONAL, -- Need R

| | |
|---|---|
| schedulingRequestID-LBT-SCell-r16 | SchedulingRequestId |

OPTIONAL, -- Need R

| | |
|---|---|
| lch-BasedPrioritization-r16 | ENUMERATED {enabled} |

OPTIONAL, -- Need R

| | |
|---|---|
| schedulingRequestID-BFR-SCell-r16 | SchedulingRequestId |

OPTIONAL, -- Need R

drx-ConfigSecondaryGroup-r16 SetupRelease { DRX-ConfigSecondaryGroup }

OPTIONAL -- Need M

| | |
|---|---|
| schedulingRequestID-BFR-TRP-r17 | SchedulingRequestId |

OPTIONAL, -- Need R
]]
}

| | |
|---|---|
| DataInactivityTimer ::= | ENUMERATED {s1, s2, s3, s5, s7, s10, s15, s20, s40, s50, |

s60, s80, s100, s120, s150, s180}
-- TAG-MAC-CELLGROUPCONFIG-STOP
-- ASN1STOP

TABLE 2
MAC-CellGroupConfig field descriptions

usePreBSR
If set to true, the MAC entity of the IAB-MT may use the Pre-emptive BSR, see TS 38.321
[3].
csi-Mask
If set to true, the UE limits CSI reports to the on-duration period of the DRX cycle, see TS
38.321 [3].
dataInactivityTimer
Releases the RRC connection upon data inactivity as specified in clause 5.3.8.5 and in TS
38.321 [3]. Value s1 corresponds to 1 second, value s2 corresponds to 2 seconds, and so on.
drx-Config
Used to configure DRX as specified in TS 38.321 [3].
drx-ConfigSecondaryGroup
Used to configure DRX related parameters for the second DRX group as specified in TS
38.321 [3]. The network does not configure secondary DRX group with DCP simultaneously
nor secondary DRX group with a dormant BWP simultaneously.
lch-BasedPrioritization
If this field is present, the corresponding MAC entity of the UE is configured with
prioritization between overlapping grants and between scheduling request and overlapping
grants based on LCH priority, see TS 38.321 [3].
schedulingRequestID-BFR-SCell
Indicates the scheduling request configuration applicable for BFR on SCell, as specified in
TS 38.321 [3].
schedulingRequestID-LBT-SCell
Indicates the scheduling request configuration applicable for consistent uplink LBT recovery
on SCell, as specified in TS 38.321 [3].
schedulingRequestID-BFR-TRP
Indicates the scheduling request configuration applicable for TRP specific BFR, as
specified in TS 38.321 [3].
skipUplinkTxDynamic
If set to true, the UE skips UL transmissions as described in TS 38.321 [3].
tag-Config
The field is used to configure parameters for a time-alignment group. The field is not present
if any DAPS bearer is configured.

As another example, a set of SR IDs are configured and included in IE MAC-CellGroup Config. As shown in Tables 3 and 4:

TABLE 3
MAC-CellGroupConfig information element

-- ASN1START
-- TAG-MAC-CELLGROUPCONFIG-START

| | |
|---|---|
| MAC-CellGroupConfig ::= | SEQUENCE { |

| | |
|---|---|
| drx-Config | SetupRelease { DRX-Config } |

OPTIONAL, -- Need M

| | |
|---|---|
| schedulingRequestConfig | SchedulingRequestConfig |

OPTIONAL, -- Need M

| | |
|---|---|
| bsr-Config | BSR-Config |

OPTIONAL, -- Need M

| | |
|---|---|
| tag-Config | TAG-Config |

OPTIONAL, -- Need M

| | |
|---|---|
| phr-Config | SetupRelease { PHR-Config } |

OPTIONAL, -- Need M

| skipUplinkTxDynamic | BOOLEAN, |
|---|---|
| . . . , | |
| [[ | |
| csi-Mask | BOOLEAN |

OPTIONAL, -- Need M

dataInactivityTimer SetupRelease { DataInactivityTimer } OPTIONAL --

Cond MCG-Only

| ]], | |
|---|---|
| [[ | |
| usePreBSR-r16 | ENUMERATED {true} |

OPTIONAL, -- Need R

| | |
|---|---|
| schedulingRequestID-LBT-SCell-r16 | SchedulingRequestId |

OPTIONAL, -- Need R

| | |
|---|---|
| lch-BasedPrioritization-r16 | ENUMERATED {enabled} |

OPTIONAL, -- Need R

| | |
|---|---|
| schedulingRequestID-BFR-SCell-r16 | SchedulingRequestId |

OPTIONAL, -- Need R

drx-ConfigSecondaryGroup-r16 SetupRelease { DRX-ConfigSecondaryGroup }

OPTIONAL -- Need M

schedulingRequestIDList-BFR-TRP-r17 SEQUENCE (SIZE (1..

maxNrofSR-TRP-BFR) OF SchedulingRequestId OPTIONAL, --
Need R
]]
}

| | |
|---|---|
| DataInactivityTimer ::= | ENUMERATED {s1, s2, s3, s5, s7, s10, s15, s20, s40, s50, |

s60, s80, s100, s120, s150, s180}
-- TAG-MAC-CELLGROUPCONFIG-STOP
-- ASN1STOP

TABLE 4
MAC-CellGroupConfig field descriptions

usePreBSR
If set to true, the MAC entity of the IAB-MT may use the Pre-emptive BSR, see TS 38.321
[3].
csi-Mask
If set to true, the UE limits CSI reports to the on-duration period of the DRX cycle, see TS
38.321 [3].
dataInactivityTimer
Releases the RRC connection upon data inactivity as specified in clause 5.3.8.5 and in TS
38.321 [3]. Value s1 corresponds to 1 second, value s2 corresponds to 2 seconds, and so on.
drx-Config
Used to configure DRX as specified in TS 38.321 [3].
drx-ConfigSecondaryGroup
Used to configure DRX related parameters for the second DRX group as specified in TS
38.321 [3]. The network does not configure secondary DRX group with DCP simultaneously
nor secondary DRX group with a dormant BWP simultaneously.
lch-BasedPrioritization
If this field is present, the corresponding MAC entity of the UE is configured with
prioritization between overlapping grants and between scheduling request and overlapping
grants based on LCH priority, see TS 38.321 [3].
schedulingRequestID-BFR-SCell
Indicates the scheduling request configuration applicable for BFR on SCell, as specified in
TS 38.321 [3].
schedulingRequestID-LBT-SCell
Indicates the scheduling request configuration applicable for consistent uplink LBT recovery
on SCell, as specified in TS 38.321 [3].
schedulingRequestIDList-BFR-TRP
List of the scheduling request configuration applicable for TRP specific BFR, as
specified in TS 38.321 [3].
skipUplinkTxDynamic
If set to true, the UE skips UL transmissions as described in TS 38.321 [3].
tag-Config
The field is used to configure parameters for a time-alignment group. The field is not present
if any DAPS bearer is configured.

For another example, an SR ID is configured and included in IE CellGroupConfig. As shown in Tables 5 and 6:

TABLE 5
The CellGroupConfig IE is used to configure a master cell group (MCG) or secondary cell group (SCG).
A cell group comprises of one MAC entity, a set of logical channels with associated RLC entities and of a
primary cell (SpCell) and one or more secondary cells (SCells).
CellGroupConfig information element

-- ASN1START
-- TAG-CELLGROUPCONFIG-START
-- Configuration of one Cell-Group:

| | |
|---|---|
| CellGroupConfig ::= | SEQUENCE { |

| | |
|---|---|
| cellGroupId | CellGroupId, |
| rlc-BearerToAddModList | SEQUENCE (SIZE(1..maxLC-ID)) OF RLC- |

BearerConfig OPTIONAL, -- Need N

rlc-BearerToReleaseList SEQUENCE (SIZE(1..maxLC-ID)) OF

| | |
|---|---|
| LogicalChannelIdentity | OPTIONAL, -- Need N |

| | |
|---|---|
| mac-CellGroupConfig | MAC-CellGroupConfig |

OPTIONAL, -- Need M

| | |
|---|---|
| physicalCellGroupConfig | PhysicalCellGroupConfig |

OPTIONAL, -- Need M

| | |
|---|---|
| spCellConfig | SpCellConfig |

OPTIONAL, -- Need M

| | |
|---|---|
| sCellToAddModList | SEQUENCE (SIZE (1..maxNrofSCells)) OF |

| | |
|---|---|
| SCellConfig | OPTIONAL, -- Need N |

| | |
|---|---|
| sCellToReleaseList | SEQUENCE (SIZE (1..maxNrofSCells)) OF |

| | |
|---|---|
| SCellIndex | OPTIONAL, -- Need N |

| . . . , | | |
|---|---|---|
| [[ | | |
| reportUplinkTxDirectCurrent | ENUMERATED {true} | OPTIONAL |

-- Cond BWP-Reconfig

| ]], | |
|---|---|
| [[ | |
| bap-Address-r16 | BIT STRING (SIZE (10)) |

OPTIONAL, -- Need M

| | |
|---|---|
| bh-RLC-ChannelToAddModList-r16 | SEQUENCE (SIZE(1..maxBH- |

RLC-ChannelID-r16)) OF BH-RLC-ChannelConfig-r16 OPTIONAL, -- Need N

| | |
|---|---|
| bh-RLC-ChannelToReleaseList-r16 | SEQUENCE (SIZE(1..maxBH- |

| | |
|---|---|
| RLC-ChannelID-r16)) OF BH-RLC-ChannelID-r16 | OPTIONAL, -- Need N |

| | |
|---|---|
| f1c-TransferPath-r16 | ENUMERATED {lte, nr, both} |

OPTIONAL, -- Need M

| | |
|---|---|
| simultaneousTCI-UpdateList1-r16 | SEQUENCE (SIZE |

| | |
|---|---|
| (1..maxNrofServingCellsTCI-r16)) OF ServCellIndex | OPTIONAL, -- Need R |

| | |
|---|---|
| simultaneousTCI-UpdateList2-r16 | SEQUENCE (SIZE |

| | |
|---|---|
| (1..maxNrofServingCellsTCI-r16)) OF ServCellIndex | OPTIONAL, -- Need R |

| | |
|---|---|
| simultaneousSpatial-UpdatedList1-r16 | SEQUENCE (SIZE |

| | |
|---|---|
| (1..maxNrofServingCellsTCI-r16)) OF ServCellIndex | OPTIONAL, -- Need R |

| | |
|---|---|
| simultaneousSpatial-UpdatedList2-r16 | SEQUENCE (SIZE |

| | |
|---|---|
| (1..maxNrofServingCellsTCI-r16)) OF ServCellIndex | OPTIONAL, -- Need R |

| | |
|---|---|
| uplinkTxSwitchingOption-r16 | ENUMERATED {switchedUL, dualUL} |

OPTIONAL, -- Need R

| | |
|---|---|
| uplinkTxSwitchingPowerBoosting-r16 | ENUMERATED {enabled} |

OPTIONAL -- Need R

| | |
|---|---|
| schedulingRequestID-BFR-TRP-r17 | SchedulingRequestId |

OPTIONAL, -- Need R
]]
}
-- Serving cell specific MAC and PHY parameters for a SpCell:

| | |
|---|---|
| SpCellConfig ::= | SEQUENCE { |

| | |
|---|---|
| servCellIndex | ServCellIndex |

OPTIONAL, -- Cond SCG

reconfigurationWithSync ReconfigurationWithSync OPTIONAL, -- Cond

ReconfWithSync

rlf-TimersAndConstants SetupRelease { RLF-TimersAndConstants }

OPTIONAL, -- Need M

| | |
|---|---|
| rlmInSyncOutOfSyncThreshold | ENUMERATED {n1} |

OPTIONAL, -- Need S

| | |
|---|---|
| spCellConfigDedicated | ServingCellConfig |

OPTIONAL, -- Need M

. . .

}

| | |
|---|---|
| ReconfigurationWithSync ::= | SEQUENCE { |

| | |
|---|---|
| spCellConfigCommon | ServingCellConfigCommon |

OPTIONAL, -- Need M

| | |
|---|---|
| newUE-Identity | RNTI-Value, |

| | |
|---|---|
| t304 | ENUMERATED {ms50, ms100, ms150, ms200, |

ms500, ms1000, ms2000, ms10000},

| | |
|---|---|
| rach-ConfigDedicated | CHOICE { |

| | |
|---|---|
| uplink | RACH-ConfigDedicated, |

| | |
|---|---|
| supplementaryUplink | RACH-ConfigDedicated |

}

OPTIONAL, -- Need N

| . . . , | |
|---|---|
| [[ | |
| smtc | SSB-MTC |

OPTIONAL -- Need S

| ]], | |
|---|---|
| [[ | |
| daps-UplinkPowerConfig-r16 | DAPS-UplinkPowerConfig-r16 |

OPTIONAL -- Need N

]]

}

| | |
|---|---|
| DAPS-UplinkPowerConfig-r16 ::= | SEQUENCE { |

| | |
|---|---|
| p-DAPS-Source-r16 | P-Max, |

| | |
|---|---|
| p-DAPS-Target-r16 | P-Max, |

| | |
|---|---|
| uplinkPowerSharingDAPS-Mode-r16 | ENUMERATED {semi-static-mode1, |

semi-static-mode2, dynamic }
}

| | |
|---|---|
| SCellConfig ::= | SEQUENCE { |

| | |
|---|---|
| sCellIndex | SCellIndex, |

| | |
|---|---|
| sCellConfigCommon | ServingCellConfigCommon OPTIONAL, |

-- Cond SCellAdd

| | |
|---|---|
| sCellConfigDedicated | ServingCellConfig OPTIONAL, -- |

Cond SCellAddMod

| . . . , | |
|---|---|
| [[ | |
| smtc | SSB-MTC OPTIONAL |

-- Need S

| ]], | |
|---|---|
| [[ | |
| sCellState-r16 | ENUMERATED {activated} OPTIONAL, |

-- Cond SCellAddSync

| | |
|---|---|
| secondaryDRX-GroupConfig-r16 | ENUMERATED {true} OPTIONAL |

-- Cond DRX-Config2

]]}

-- TAG-CELLGROUPCONFIG-STOP
-- ASN1STOP

TABLE 6
CellGroupConfig field descriptions

bap-Address
BAP address of the parent node in cell group.
bh-RLC-ChannelToAddModList
Configuration of the backhaul RLC entities and the corresponding MAC Logical Channels
to be added and modified.
bh-RLC-ChannelToReleaseList
List of the backhaul RLC entities and the corresponding MAC Logical Channels to be
released.
f1c-TransferPath
The F1-C transfer path that an EN-DC IAB-MT should use for transferring F1-C packets to
the IAB-donor-CU. If IAB-MT is configured with lte, IAB-MT can only use LTE leg for F1-
C transfer. If IAB-MT is configured with nr, IAB-MT can only use NR leg for F1-C transfer.
If IAB-MT is configured with both, it is up to IAB-MT to select an LTE leg or a NR leg for
F1-C transfer. If the field is not configured, the IAB node uses the NR leg as the default one.
mac-CellGroupConfig
MAC parameters applicable for the entire cell group.
rlc-BearerToAddModList
Configuration of the MAC Logical Channel, the corresponding RLC entities and association
with radio bearers.
reportUplinkTxDirectCurrent
Enables reporting of uplink and supplementary uplink Direct Current location information
upon BWP configuration and reconfiguration. This field is only present when the BWP
configuration is modified or any serving cell is added or removed. This field is absent in the
IE CellGroupConfig when provided as part of RRCSetup message. If UE is configured with
SUL carrier, UE reports both UL and SUL Direct Current locations.
rlmInSyncOutOfSyncThreshold
BLER threshold pair index for IS/OOS indication generation, see TS 38.133 [14], table 8.1.1-
1. n1 corresponds to the value 1. When the field is absent, the UE applies the value 0.
Whenever this is reconfigured, UE resets N310 and N311, and stops T310, if running.
Network does not include this field.
sCellState
Indicates whether the SCell shall be considered to be in activated state upon SCell
configuration.
sCellToAddModList
List of secondary serving cells (SCells) to be added or modified.
sCellToReleaseList
List of secondary serving cells (SCells) to be released.
schedulingRequestID-BFR-TRP
Indicates the scheduling request configuration applicable for TRP specific BFR, as
specified in TS 38.321 [3].
secondaryDRX-GroupConfig
The field is used to indicate whether the SCell belongs to the secondary DRX group. All
serving cells in the secondary DRX group shall belong to one Frequency Range and all
serving cells in the legacy DRX group shall belong to another Frequency Range.
simultaneousTCI-UpdateList1, simultaneousTCI-UpdateList2
List of serving cells which can be updated simultaneously for TCI relation with a MAC CE.
The simultaneousTCI-UpdateList1 and simultaneousTCI-UpdateList2 shall not contain same
serving cells. Network should not configure serving cells that are configured with a BWP
with two different values for the coresetPoolIndex in these lists.
simultaneousSpatial-UpdatedList1, simultaneousSpatial-UpdatedList2
List of serving cells which can be updated simultaneously for spatial relation with a MAC
CE. The simultaneousSpatial-UpdatedList1 and simultaneousSpatial-UpdatedList2 shall not
contain same serving cells. Network should not configure serving cells that are configured
with a BWP with two different values for the coresetPoolIndex in these lists.
spCellConfig
Parameters for the SpCell of this cell group (PCell of MCG or PSCell of SCG).
uplinkTxSwitchingOption
Indicates which option is configured for dynamic UL Tx switching for inter-band UL CA or
(NG)EN-DC. The field is set to switchedUL if network configures option 1 as specified in
TS 38.214 [19], or dualUL if network configures option 2 as specified in TS 38.214 [19].
Network always configures UE with a value for this field in inter-band UL CA case and
(NG)EN-DC case where UE supports dynamic UL Tx switching.
uplinkTxSwitchingPowerBoosting
Indicates whether the UE is allowed to enable 3dB boosting on the maximum output power
for transmission on carrier2 under the operation state in which 2-port transmission can be
supported on carrier2 for inter-band UL CA case with dynamic UL Tx switching as defined
in TS 38.101-1 [15]. Network can only configure this field for dynamic UL Tx switching in
inter-band UL CA case with power Class 3 as defined in TS 38.101-1 [15].

As another example, a set of SR IDs are configured and included in IE CellGroupConfig. As shown in Tables 7 and 8:

TABLE 7
CellGroupConfig information element

-- ASN1START
-- TAG-CELLGROUPCONFIG-START
-- Configuration of one Cell-Group:

| | |
|---|---|
| CellGroupConfig ::= | SEQUENCE { |

| | |
|---|---|
| cellGroupId | CellGroupId, |
| rlc-BearerToAddModList | SEQUENCE (SIZE(1..maxLC-ID)) OF RLC- |

BearerConfig OPTIONAL, -- Need N

| | |
|---|---|
| rlc-BearerToReleaseList | SEQUENCE (SIZE(1..maxLC-ID)) OF |

| | |
|---|---|
| LogicalChannelIdentity | OPTIONAL, -- Need N |

| | |
|---|---|
| mac-CellGroupConfig | MAC-CellGroupConfig |

OPTIONAL, -- Need M

| | |
|---|---|
| physicalCellGroupConfig | PhysicalCellGroupConfig |

OPTIONAL, -- Need M

| | |
|---|---|
| spCellConfig | SpCellConfig |

OPTIONAL, -- Need M

| | |
|---|---|
| sCellToAddModList | SEQUENCE (SIZE (1..maxNrofSCells)) OF |

| | |
|---|---|
| SCellConfig | OPTIONAL, -- Need N |

| | |
|---|---|
| sCellToReleaseList | SEQUENCE (SIZE (1..maxNrofSCells)) OF |

| | |
|---|---|
| SCellIndex | OPTIONAL, -- Need N |

| . . . , | |
|---|---|
| [[ | |
| reportUplinkTxDirectCurrent | ENUMERATED {true} OPTIONAL |

-- Cond BWP-Reconfig

| ]], | |
|---|---|
| [[ | |
| bap-Address-r16 | BIT STRING (SIZE (10)) |

OPTIONAL, -- Need M

| | |
|---|---|
| bh-RLC-ChannelToAddModList-r16 | SEQUENCE (SIZE(1..maxBH- |

RLC-ChannelID-r16)) OF BH-RLC-ChannelConfig-r16 OPTIONAL, -- Need N

| | |
|---|---|
| bh-RLC-ChannelToReleaseList-r16 | SEQUENCE (SIZE(1..maxBH- |

RLC-ChannelID-r16)) OF BH-RLC-ChannelID-r16 OPTIONAL, -- Need N

| | |
|---|---|
| f1c-TransferPath-r16 | ENUMERATED {lte, nr, both} |

OPTIONAL, -- Need M

| | |
|---|---|
| simultaneousTCI-UpdateList1-r16 | SEQUENCE (SIZE |

| | |
|---|---|
| (1..maxNrofServingCellsTCI-r16)) OF ServCellIndex | OPTIONAL, -- Need R |

| | |
|---|---|
| simultaneousTCI-UpdateList2-r16 | SEQUENCE (SIZE |

| | |
|---|---|
| (1..maxNrofServingCellsTCI-r16)) OF ServCellIndex | OPTIONAL, -- Need R |

| | |
|---|---|
| simultaneousSpatial-UpdatedList1-r16 | SEQUENCE (SIZE |

| | |
|---|---|
| (1..maxNrofServingCellsTCI-r16)) OF ServCellIndex | OPTIONAL, -- Need R |

| | |
|---|---|
| simultaneousSpatial-UpdatedList2-r16 | SEQUENCE (SIZE |

| | |
|---|---|
| (1..maxNrofServingCellsTCI-r16)) OF ServCellIndex | OPTIONAL, -- Need R |

| | |
|---|---|
| uplinkTxSwitchingOption-r16 | ENUMERATED {switchedUL, dualUL} |

OPTIONAL, -- Need R

| | |
|---|---|
| uplinkTxSwitchingPowerBoosting-r16 | ENUMERATED {enabled} |

OPTIONAL -- Need R

| | |
|---|---|
| schedulingRequestIDList-BFR-TRP-r17 | SEQUENCE (SIZE (1.. |

| | |
|---|---|
| maxNrofSR-TRP-BFR) OF SchedulingRequestId | OPTIONAL, -- |

Need R
]]
}
--Serving cell specific MAC and PHY parameters for a SpCell:

| | |
|---|---|
| SpCellConfig ::= | SEQUENCE { |

| | |
|---|---|
| servCellIndex | ServCellIndex |

OPTIONAL, -- Cond SCG

reconfigurationWithSync ReconfigurationWithSync OPTIONAL, -- Cond

ReconfWithSync

rlf-TimersAndConstants SetupRelease { RLF-TimersAndConstants }

OPTIONAL, -- Need M

| | |
|---|---|
| rlmInSyncOutOfSyncThreshold | ENUMERATED {n1} |

OPTIONAL, -- Need S

| | |
|---|---|
| spCellConfigDedicated | ServinCellConfig |

OPTIONAL, -- Need M

. . .

}

| | |
|---|---|
| ReconfigurationWithSync ::= | SEQUENCE { |

| | |
|---|---|
| spCellConfigCommon | ServingCellConfigCommon |

OPTIONAL, -- Need M

| | |
|---|---|
| newUE-Identity | RNTI-Value, |

| | |
|---|---|
| t304 | ENUMERATED {ms50, ms100, ms150, ms200, |

ms500, ms1000, ms2000, ms10000},

| | |
|---|---|
| rach-ConfigDedicated | CHOICE { |

| | |
|---|---|
| uplink | RACH-ConfigDedicated, |

| | |
|---|---|
| supplementaryUplink | RACH-ConfigDedicated |

}

OPTIONAL, -- Need N

| . . . , | |
|---|---|
| [[ | |
| smtc | SSB-MTC |

OPTIONAL -- Need S

| ]], | |
|---|---|
| [[ | |
| daps-UplinkPowerConfig-r16 | DAPS-UplinkPowerConfig-r16 |

OPTIONAL -- Need N

]]

}

| | |
|---|---|
| DAPS-UplinkPowerConfig-r16 ::= | SEQUENCE { |

| | |
|---|---|
| p-DAPS-Source-r16 | P-Max, |

| | |
|---|---|
| p-DAPS-Target-r16 | P-Max, |

| | |
|---|---|
| uplinkPowerSharingDAPS-Mode-r16 | ENUMERATED {semi-static-mode1, |

semi-static-mode2, dynamic }
}

| | |
|---|---|
| SCellConfig ::= | SEQUENCE { |

| | |
|---|---|
| sCellIndex | SCellIndex, |

| | |
|---|---|
| sCellConfigCommon | ServingCellConfigCommon OPTIONAL, |

-- Cond SCellAdd

| | | |
|---|---|---|
| sCellConfigDedicated | ServingCellConfig | OPTIONAL, -- |

Cond SCellAddMod

| . . . , | | |
|---|---|---|
| [[ | | |
| smtc | SSB-MTC | OPTIONAL |

-- Need S

| ]], | |
|---|---|
| [[ | |
| sCellState-r16 | ENUMERATED {activated} OPTIONAL, |

-- Cond SCellAddSync

| | | |
|---|---|---|
| secondaryDRX-GroupConfig-r16 | ENUMERATED {true} | OPTIONAL |

-- Cond DRX-Config2

]]}

-- TAG-CELLGROUPCONFIG-STOP
-- ASN1STOP

TABLE 8
CellGroupConfig field descriptions

bap-Address
BAP address of the parent node in cell group.
bh-RLC-ChannelToAddModList
Configuration of the backhaul RLC entities and the corresponding MAC Logical Channels
to be added and modified.
bh-RLC-ChannelToReleaseList
List of the backhaul RLC entities and the corresponding MAC Logical Channels to be
released.
f1c-TransferPath
The F1-C transfer path that an EN-DC IAB-MT should use for transferring F1-C packets to
the IAB-donor-CU. If IAB-MT is configured with lte, IAB-MT can only use LTE leg for F1-
C transfer. If IAB-MT is configured with nr, IAB-MT can only use NR leg for F1-C transfer.
If IAB-MT is configured with both, it is up to IAB-MT to select an LTE leg or a NR leg for
F1-C transfer. If the field is not configured, the IAB node uses the NR leg as the default one.
mac-CellGroupConfig
MAC parameters applicable for the entire cell group.
rlc-BearerToAddModList
Configuration of the MAC Logical Channel, the corresponding RLC entities and association
with radio bearers.
reportUplinkTxDirectCurrent
Enables reporting of uplink and supplementary uplink Direct Current location information
upon BWP configuration and reconfiguration. This field is only present when the BWP
configuration is modified or any serving cell is added or removed. This field is absent in the
IE CellGroupConfig when provided as part of RRCSetup message. If UE is configured with
SUL carrier, UE reports both UL and SUL Direct Current locations.
rlmInSyncOutOfSyncThreshold
BLER threshold pair index for IS/OOS indication generation, see TS 38.133 [14], table 8.1.1-
1. n1 corresponds to the value 1. When the field is absent, the UE applies the value 0.
Whenever this is reconfigured, UE resets N310 and N311, and stops T310, if running.
Network does not include this field.
sCellState
Indicates whether the SCell shall be considered to be in activated state upon SCell
configuration.
sCellToAddModList
List of secondary serving cells (SCells) to be added or modified.
sCellToReleaseList
List of secondary serving cells (SCells) to be released.
schedulingRequestIDList-BFR-TRP
List of the scheduling request configuration applicable for TRP specific BFR, as
specified in TS 38.321 [3].
secondaryDRX-GroupConfig
The field is used to indicate whether the SCell belongs to the secondary DRX group. All
serving cells in the secondary DRX group shall belong to one Frequency Range and all
serving cells in the legacy DRX group shall belong to another Frequency Range.
simultaneousTCI-UpdateList1, simultaneousTCI-UpdateList2
List of serving cells which can be updated simultaneously for TCI relation with a MAC CE.
The simultaneousTCI-UpdateList1 and simultaneousTCI-UpdateList2 shall not contain same
serving cells. Network should not configure serving cells that are configured with a BWP
with two different values for the coresetPoolIndex in these lists.
simultaneousSpatial-UpdatedList1, simultaneousSpatial-UpdatedList2
List of serving cells which can be updated simultaneously for spatial relation with a MAC
CE. The simultaneousSpatial-UpdatedList1 and simultaneousSpatial-UpdatedList2 shall not
contain same serving cells. Network should not configure serving cells that are configured
with a BWP with two different values for the coresetPoolIndex in these lists.
spCellConfig
Parameters for the SpCell of this cell group (PCell of MCG or PSCell of SCG).
uplinkTxSwitchingOption
Indicates which option is configured for dynamic UL Tx switching for inter-band UL CA or
(NG)EN-DC. The field is set to switchedUL if network configures option 1 as specified in
TS 38.214 [19], or dualUL if network configures option 2 as specified in TS 38.214 [19].
Network always configures UE with a value for this field in inter-band UL CA case and
(NG)EN-DC case where UE supports dynamic UL Tx switching.
uplinkTxSwitchingPowerBoosting
Indicates whether the UE is allowed to enable 3dB boosting on the maximum output power
for transmission on carrier2 under the operation state in which 2-port transmission can be
supported on carrier2 for inter-band UL CA case with dynamic UL Tx switching as defined
in TS 38.101-1 [15]. Network can only configure this field for dynamic UL Tx switching in
inter-band UL CA case with power Class 3 as defined in TS 38.101-1 [15].

In some embodiments, the configuration values of the TRP-specific beam failure recovery SR ID and the control resource pool index (e.g., SchedulingRequestId+coresetPool Index-r16) are the same as the configuration value of the cell-specific beam failure recovery SR ID, or the configuration values of the TRP-specific beam failure recovery SR ID and the control resource pool index are different from the configuration value of the cell-specific beam failure recovery SR ID.

For example, control resource pool index: coresetPoolIndex-r16=0/1; the present application is not limited thereto.

For example, an SR ID is configured and included in IE MAC-CellGroupConfig. As shown in Tables 9 to 11:

TABLE 9
MAC-CellGroupConfig information element

-- ASN1START
-- TAG-MAC-CELLGROUPCONFIG-START

| | |
|---|---|
| MAC-CellGroupConfig ::= | SEQUENCE { |

| | |
|---|---|
| drx-Config | SetupRelease { DRX-Config } |

OPTIONAL, -- Need M

| | |
|---|---|
| schedulingRequestConfig | SchedulingRequestConfig |

OPTIONAL, -- Need M

| | |
|---|---|
| bsr-Config | BSR-Config |

OPTIONAL, -- Need M

| | |
|---|---|
| tag-Config | TAG-Config |

OPTIONAL, -- Need M

| | |
|---|---|
| phr-Config | SetupRelease { PHR-Config } |

OPTIONAL, -- Need M

| skipUplinkTxDynamic | BOOLEAN, |
|---|---|
| . . . , | |
| [[ | |
| csi-Mask | BOOLEAN |

OPTIONAL, -- Need M

| | |
|---|---|
| dataInactivity Timer | SetupRelease { DataInactivityTimer } OPTIONAL -- |

Cond MCG-Only

| ]], | |
|---|---|
| [[ | |
| usePreBSR-r16 | ENUMERATED {true} |

OPTIONAL, -- Need R

| | |
|---|---|
| schedulingRequestID-LBT-SCell-r16 | SchedulingRequestId |

OPTIONAL, -- Need R

| | |
|---|---|
| lch-BasedPrioritization-r16 | ENUMERATED {enabled} |

OPTIONAL, -- Need R

| | |
|---|---|
| schedulingRequestID-BFR-SCell-r16 | SchedulingRequestId |

OPTIONAL, -- Need R

drx-ConfigSecondaryGroup-r16 SetupRelease { DRX-ConfigSecondaryGroup }

OPTIONAL -- Need M

| | |
|---|---|
| schedulingRequestID-BFR-TRP-r17 | SchedulingRequestId-BFR-TRP |

OPTIONAL, -- Need R
]]
}

| | |
|---|---|
| DataInactivityTimer ::= | ENUMERATED {s1, s2, s3, s5, s7, s10, s15, s20, s40, |

s50, s60, s80, s100, s120, s150, s180}
SchedulingRequestId-BFR-TRP ::= SEQUENCE {

| | |
|---|---|
| coresetPoolIndex-r17 | INTEGER (0..1) |

OPTIONAL, -- Need R

| | |
|---|---|
| schedulingRequestId | SchedulingRequestId |

}
-- TAG-MAC-CELLGROUPCONFIG-STOP
-- ASN1STOP

TABLE 10
MAC-CellGroupConfig field descriptions

usePreBSR
If set to true, the MAC entity of the IAB-MT may use the Pre-emptive BSR, see TS 38.321
[3].
csi-Mask
If set to true, the UE limits CSI reports to the on-duration period of the DRX cycle, see TS
38.321 [3].
dataInactivityTimer
Releases the RRC connection upon data inactivity as specified in clause 5.3.8.5 and in TS
38.321 [3]. Value s1 corresponds to 1 second, value s2 corresponds to 2 seconds, and so on.
drx-Config
Used to configure DRX as specified in TS 38.321 [3].
drx-ConfigSecondaryGroup
Used to configure DRX related parameters for the second DRX group as specified in TS
38.321 [3]. The network does not configure secondary DRX group with DCP simultaneously
nor secondary DRX group with a dormant BWP simultaneously.
lch-BasedPrioritization
If this field is present, the corresponding MAC entity of the UE is configured with
prioritization between overlapping grants and between scheduling request and overlapping
grants based on LCH priority, see TS 38.321 [3].
schedulingRequestID-BFR-SCell
Indicates the scheduling request configuration applicable for BFR on SCell, as specified in TS
38.321 [3].
schedulingRequestID-LBT-SCell
Indicates the scheduling request configuration applicable for consistent uplink LBT recovery
on SCell, as specified in TS 38.321 [3].
schedulingRequestID-BFR-TRP
Indicates the scheduling request configuration applicable for TRP specific BFR, as
specified in TS 38.321 [3].
skipUplinkTxDynamic
If set to true, the UE skips UL transmissions as described in TS 38.321 [3].
tag-Config
The field is used to configure parameters for a time-alignment group. The field is not present
if any DAPS bearer is configured.

TABLE 11
schedulingRequestID-BFR-TRP field descriptions

coresetPoolIndex-r17
The index of the CORESET pool for which this scheduling request
configuration is applicable.
If the field is absent, the UE applies the value 0

For another example, an SR ID is configured and included in IE CellGroupConfig. As shown in Tables 12 to 14:

TABLE 12
CellGroupConfig information element

-- ASN1START
-- TAG-CELLGROUPCONFIG-START
-- Configuration of one Cell-Group:

| | |
|---|---|
| CellGroupConfig ::= | SEQUENCE { |

| | |
|---|---|
| cellGroupId | CellGroupId, |
| rlc-BearerToAddModList | SEQUENCE (SIZE(1..maxLC-ID)) OF RLC- |

BearerConfig OPTIONAL, -- Need N

| | |
|---|---|
| rlc-BearerToReleaseList | SEQUENCE (SIZE(1..maxLC-ID)) OF |

| | |
|---|---|
| LogicalChannelIdentity | OPTIONAL, -- Need N |

| | |
|---|---|
| mac-CellGroupConfig | MAC-CellGroupConfig |

OPTIONAL, -- Need M

| | |
|---|---|
| physicalCellGroupConfig | PhysicalCellGroupConfig |

OPTIONAL, -- Need M

| | |
|---|---|
| spCellConfig | SpCellConfig |

OPTIONAL, -- Need M

| | |
|---|---|
| sCellToAddModList | SEQUENCE (SIZE (1..maxNrofSCells)) OF |

| | |
|---|---|
| SCellConfig | OPTIONAL, -- Need N |

| | |
|---|---|
| sCellToReleaseList | SEQUENCE (SIZE (1..maxNrofSCells)) OF |

| | |
|---|---|
| SCellIndex | OPTIONAL, -- Need N |

| . . . , | |
|---|---|
| [[ | |
| reportUplinkTxDirectCurrent | ENUMERATED {true} OPTIONAL - |

- Cond BWP-Reconfig

| ]], | |
|---|---|
| [[ | |
| bap-Address-r16 | BIT STRING (SIZE (10)) |

OPTIONAL, -- Need M

| | |
|---|---|
| bh-RLC-ChannelToAddModList-r16 | SEQUENCE (SIZE(1..maxBH- |

RLC-ChannelID-r16)) OF BH-RLC-ChannelConfig-r16 OPTIONAL, -- Need N

| | |
|---|---|
| bh-RLC-ChannelToReleaseList-r16 | SEQUENCE (SIZE(1..maxBH- |

| | |
|---|---|
| RLC-ChannelID-r16)) OF BH-RLC-ChannelID-r16 | OPTIONAL, -- Need N |

| | |
|---|---|
| f1c-TransferPath-r16 | ENUMERATED {lte, nr, both} |

OPTIONAL, -- Need M

| | |
|---|---|
| simultaneousTCI-UpdateList1-r16 | SEQUENCE (SIZE |

| | |
|---|---|
| (1..maxNrofServingCellsTCI-r16)) OF ServCellIndex | OPTIONAL, -- Need R |

| | |
|---|---|
| simultaneousTCI-UpdateList2-r16 | SEQUENCE (SIZE |

| | |
|---|---|
| (1..maxNrofServingCellsTCI-r16)) OF ServCellIndex | OPTIONAL, -- Need R |

| | |
|---|---|
| simultaneousSpatial-UpdatedList1-r16 | SEQUENCE (SIZE |

| | |
|---|---|
| (1..maxNrofServingCellsTCI-r16)) OF ServCellIndex | OPTIONAL, -- Need R |

| | |
|---|---|
| simultaneousSpatial-UpdatedList2-r16 | SEQUENCE (SIZE |

| | |
|---|---|
| (1..maxNrofServingCellsTCI-r16)) OF ServCellIndex | OPTIONAL, -- Need R |

| | |
|---|---|
| uplinkTxSwitchingOption-r16 | ENUMERATED {switchedUL, dualUL} |

OPTIONAL, -- Need R

| | |
|---|---|
| uplinkTxSwitchingPowerBoosting-r16 | ENUMERATED {enabled} |

OPTIONAL -- Need R

| | |
|---|---|
| schedulingRequestID-BFR-TRP-r17 | SchedulingRequestId-BFR-TRP |

OPTIONAL, -- Need R
]]
}
-- Serving cell specific MAC and PHY parameters for a SpCell:

| | |
|---|---|
| SpCellConfig ::= | SEQUENCE { |

| | |
|---|---|
| servCellIndex | ServCellIndex |

OPTIONAL, -- Cond SCG

reconfigurationWithSync ReconfigurationWithSync OPTIONAL, -- Cond

ReconfWith Sync

| | |
|---|---|
| rlf-TimersAndConstants | SetupRelease { RLF-TimersAndConstants } |

OPTIONAL, -- Need M

| | |
|---|---|
| rlmInSyncOutOfSyncThreshold | ENUMERATED {n1} |

OPTIONAL, -- Need S

| | |
|---|---|
| spCellConfigDedicated | ServingCellConfig |

OPTIONAL, -- Need M

. . .

}

| | |
|---|---|
| ReconfigurationWithSync ::= | SEQUENCE { |

| | |
|---|---|
| spCellConfigCommon | ServingCellConfigCommon |

OPTIONAL, -- Need M

| | |
|---|---|
| newUE-Identity | RNTI-Value, |

| | |
|---|---|
| t304 | ENUMERATED {ms50, ms100, ms150, ms200, |

ms500, ms1000, ms2000, ms10000},

| | |
|---|---|
| rach-ConfigDedicated | CHOICE { |

| | |
|---|---|
| uplink | RACH-ConfigDedicated, |

| | |
|---|---|
| supplementaryUplink | RACH-ConfigDedicated |

}

OPTIONAL, -- Need N

| . . . , | |
|---|---|
| [[ | |
| smtc | SSB-MTC |

OPTIONAL -- Need S

| ]], | |
|---|---|
| [[ | |
| daps-UplinkPowerConfig-r16 | DAPS-UplinkPowerConfig-r16 |

OPTIONAL -- Need N

]]

}

| | |
|---|---|
| DAPS-UplinkPowerConfig-r16 ::= | SEQUENCE { |

| | |
|---|---|
| p-DAPS-Source-r16 | P-Max, |

| | |
|---|---|
| p-DAPS-Target-r16 | P-Max, |

| | |
|---|---|
| uplinkPowerSharingDAPS-Mode-r16 | ENUMERATED {semi-static-mode1, semi- |

static-mode2, dynamic }
}

| | |
|---|---|
| SCellConfig ::= | SEQUENCE { |

| | |
|---|---|
| sCellIndex | SCellIndex, |

| | |
|---|---|
| sCellConfigCommon | ServingCellConfigCommon OPTIONAL, |

-- Cond SCellAdd

| | | |
|---|---|---|
| sCellConfigDedicated | ServingCellConfig | OPTIONAL, -- |

Cond SCellAddMod

| . . . , | | |
|---|---|---|
| [[ | | |
| smtc | SSB-MTC | OPTIONAL |

-- Need S

| ]], | |
|---|---|
| [[ | |
| sCellState-r16 | ENUMERATED {activated} OPTIONAL, -- |

Cond SCellAddSync

| | | |
|---|---|---|
| secondaryDRX-GroupConfig-r16 | ENUMERATED {true} | OPTIONAL |

-- Cond DRX-Config2

]]}

SchedulingRequestId-BFR-TRP ::= SEQUENCE {

| | |
|---|---|
| coresetPoolIndex-r17 | INTEGER (0..1) |

OPTIONAL, -- Need R

| | |
|---|---|
| schedulingRequestId | SchedulingRequestId |

}
-- TAG-CELLGROUPCONFIG-STOP
-- ASN1STOP

TABLE 13
CellGroupConfig field descriptions

bap-Address
BAP address of the parent node in cell group.
bh-RLC-ChannelToAddModList
Configuration of the backhaul RLC entities and the corresponding MAC Logical Channels to
be added and modified.
bh-RLC-ChannelToReleaseList
List of the backhaul RLC entities and the corresponding MAC Logical Channels to be
released.
f1c-TransferPath
The F1-C transfer path that an EN-DC IAB-MT should use for transferring F1-C packets to
the IAB-donor-CU. If IAB-MT is configured with lte, IAB-MT can only use LTE leg for F1-
C transfer. If IAB-MT is configured with nr, IAB-MT can only use NR leg for F1-C transfer.
If IAB-MT is configured with both, it is up to IAB-MT to select an LTE leg or a NR leg for
F1-C transfer. If the field is not configured, the IAB node uses the NR leg as the default one.
mac-CellGroupConfig
MAC parameters applicable for the entire cell group.
rlc-BearerToAddModList
Configuration of the MAC Logical Channel, the corresponding RLC entities and association
with radio bearers.
reportUplinkTxDirectCurrent
Enables reporting of uplink and supplementary uplink Direct Current location information
upon BWP configuration and reconfiguration. This field is only present when the BWP
configuration is modified or any serving cell is added or removed. This field is absent in the
IE CellGroupConfig when provided as part of RRCSetup message. If UE is configured with
SUL carrier, UE reports both UL and SUL Direct Current locations.
rlmInSyncOutOfSyncThreshold
BLER threshold pair index for IS/OOS indication generation, see TS 38.133 [14], table 8.1.1-
1. n1 corresponds to the value 1. When the field is absent, the UE applies the value 0.
Whenever this is reconfigured, UE resets N310 and N311, and stops T310, if running. Network
does not include this field.
sCellState
Indicates whether the SCell shall be considered to be in activated state upon SCell
configuration.
sCellToAddModList
List of secondary serving cells (SCells) to be added or modified.
sCellToReleaseList
List of secondary serving cells (SCells) to be released.
schedulingRequestID-BFR-TRP
Indicates the scheduling request configuration applicable for TRP specific BFR, as
specified in TS 38.321 [3].
secondaryDRX-GroupConfig
The field is used to indicate whether the SCell belongs to the secondary DRX group. All
serving cells in the secondary DRX group shall belong to one Frequency Range and all serving
cells in the legacy DRX group shall belong to another Frequency Range.
simultaneousTCI-UpdateList1, simultaneousTCI-UpdateList2
List of serving cells which can be updated simultaneously for TCI relation with a MAC CE.
The simultaneousTCI-UpdateList1 and simultaneousTCI-UpdateList2 shall not contain same
serving cells. Network should not configure serving cells that are configured with a BWP with
two different values for the coresetPoolIndex in these lists.
simultaneousSpatial-UpdatedList1, simultaneousSpatial-UpdatedList2
List of serving cells which can be updated simultaneously for spatial relation with a MAC CE.
The simultaneousSpatial-UpdatedList1 and simultaneousSpatial-UpdatedList2 shall not
contain same serving cells. Network should not configure serving cells that are configured
with a BWP with two different values for the coresetPoolIndex in these lists.
spCellConfig
Parameters for the SpCell of this cell group (PCell of MCG or PSCell of SCG).
uplinkTxSwitchingOption
Indicates which option is configured for dynamic UL Tx switching for inter-band UL CA or
(NG)EN-DC. The field is set to switchedUL if network configures option 1 as specified in TS
38.214 [19], or dualUL if network configures option 2 as specified in TS 38.214 [19]. Network
always configures UE with a value for this field in inter-band UL CA case and (NG)EN-DC
case where UE supports dynamic UL Tx switching.
uplinkTxSwitchingPowerBoosting
Indicates whether the UE is allowed to enable 3dB boosting on the maximum output power
for transmission on carrier2 under the operation state in which 2-port transmission can be
supported on carrier2 for inter-band UL CA case with dynamic UL Tx switching as defined in
TS 38.101-1 [15]. Network can only configure this field for dynamic UL Tx switching in inter-
band UL CA case with power Class 3 as defined in TS 38.101-1 [15].

TABLE 14
schedulingRequestID-BFR-TRP field descriptions

coresetPoolIndex-r17
The index of the CORESET pool for which this scheduling request
configuration is applicable.
If the field is absent, the UE applies the value 0

In some embodiments, when an MAC entity of a terminal equipment has a pending SR for a TRP-specific BFR, and for an SR transmission occasion, the MAC entity has one or more PUCCH resources overlapping with PUCCH resources of the TRP-specific BFR, the MAC entity determines (deems) that the PUCCH resources of the TRP-specific BFR are valid.

In some embodiments, when an MAC entity of a terminal equipment has a pending SR for a secondary cell/TRP-specific BFR, and for an SR transmission occasion, the MAC entity has one or more PUCCH resources overlapping with PUCCH resources of the secondary cell/TRP-specific BFR, the MAC entity determines (deems) that the PUCCH resources of the secondary cell/TRP-specific BFR are valid.

For example, the MAC entity only deems that PUCCH resources of the secondary cell/TRP-specific BFR is valid. When the MAC entity has a pending SR for the secondary cell BFR and a pending SR for the TRP-specific BFR, and for the SR transmission occasion, the MAC entity has one or more PUCCH resources overlapping with PUCCH resources of the secondary cell BFR and/or PUCCH resources of the TRP-specific BFR, which PUCCH resource is valid depends on the implementation of the terminal equipment.

In some embodiments, in the case where the terminal equipment transmits an MAC PDU and the MAC PDU includes a beam failure recovery MAC CE or a truncated beam failure recovery MAC CE, the beam failure recovery MAC CE or the truncated beam failure recovery MAC CE includes beam failure information of a cell, the MAC entity of the terminal equipment cancels the pending SR triggered for the BFR of the TRP included in the cell and stops the respective prohibiting timer; e.g., sr-ProhibitTimer.

In some embodiments, in the case where the terminal equipment transmits an MAC PDU, and the MAC PDU includes an MAC CE that includes beam failure information of a TRP, the MAC entity of the terminal equipment cancels the pending SR triggered for the BFR of the TRP and stops the respective prohibiting timer; e.g., sr-ProhibitTimer.

In some embodiments, once a secondary cell is deactivated, the MAC entity of the terminal equipment cancels the pending SR triggered for the BFR of the TRP included in the secondary cell.

In some embodiments, if all TRP-specific BFRs that triggers SR are cancelled, the MAC entity of the terminal equipment cancels the triggered pending SR.

In some embodiments, upon SR resource reconfiguration, the MAC entity of the terminal equipment cancels the pending SR.

In some embodiments, in the case where an MAC PDU performs transmission using an uplink grant except an uplink grant provided by random access response (RAR) or an uplink grant determined from the transmission of the message A payload (MSGA payload), and the MAC PDU includes an MAC CE including beam failure information of a TRP, the MAC entity of the terminal equipment stops the ongoing random access procedure due to the pending SR by the BFR of the TRP.

The above embodiments merely exemplify the embodiments of the present application, but the present application is not limited thereto, and appropriate variants may be made on the basis of the above embodiments. For example, each of the above embodiments may be used alone or in combination with one or more of the above embodiments.

It can be known from the above embodiments, the MAC entity of the terminal equipment receives a beam failure instance indication, increments a transmission reception point (TRP)-specific beam failure indication count by 1, and in a case where the TRP-specific beam failure indication count is greater than or equal to a TRP-specific beam failure instance maximum count, determines that a beam failure occurs in a transmission reception point or beam failure recovery (BFR) of the transmission reception point is triggered or a beam failure indication of the transmission reception point is triggered. Thus, not only beam failure detection at the TRP level can be triggered when only part of the beams fails, but also beam failure detection at the cell level or the TRP level can be distinguished, thereby avoiding resource waste.

### Embodiments of the Second Aspect

An embodiment of the present application provides a method for detecting beam failure, which is described from a terminal equipment. The embodiments of the second aspect combine the TRP-specific beam failure detection and the cell-specific beam failure detection, and the same content as those of the embodiments of the first aspect is not repeated.

In some embodiments, the MAC entity of the terminal equipment determines whether the beam failure instance indication is cell specific or cell level; and in the case where the beam failure instance indication is not cell specific or cell level, starts or restarts a transmission reception point (TRP)-specific beam failure detection timer.

In some embodiments, the MAC entity of the terminal equipment determines whether the beam failure instance indication is TRP specific or TRP level; and in the case where the beam failure instance indication is TRP specific or TRP level, starts or restarts the transmission reception point (TRP)-specific beam failure detection timer.

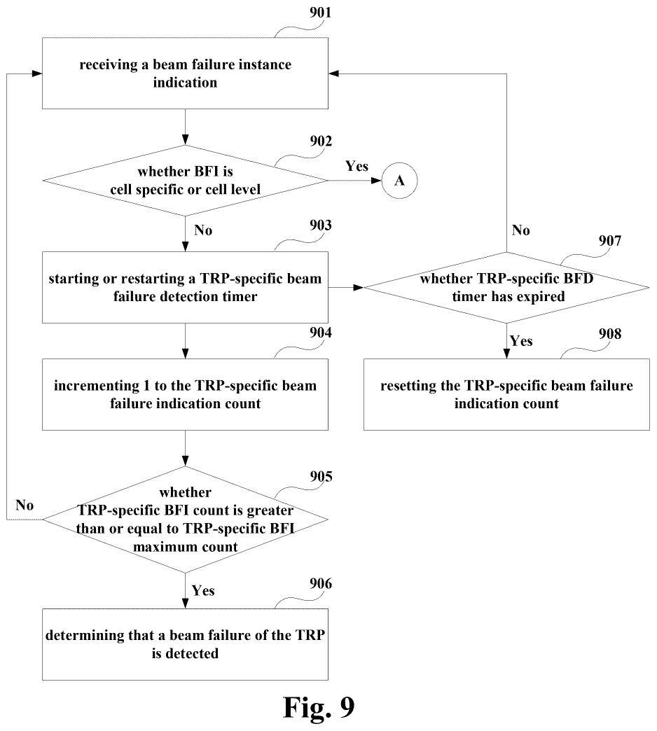

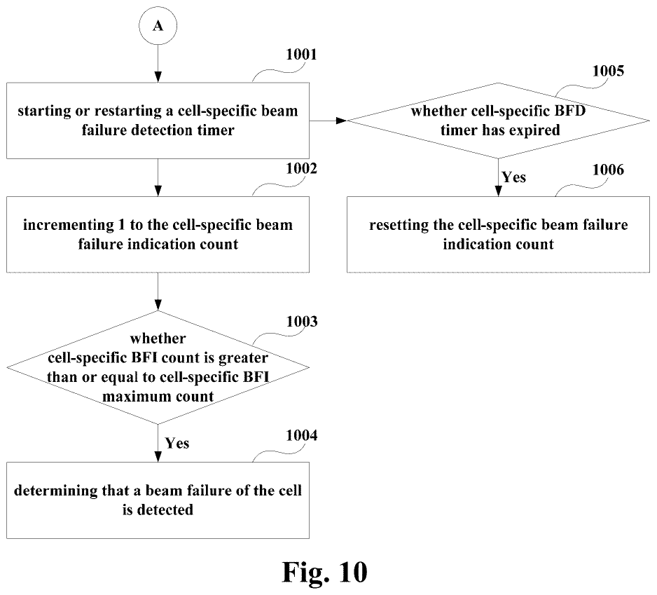

FIG. 9 is another schematic diagram of a method for detecting beam failure according to an embodiment of the present application, schematically illustrating an operation of an MAC entity of a terminal equipment. As shown in FIG. 9, the operation of the MAC entity includes:
901, receiving a beam failure instance indication from a lower layer;
902, determining whether the beam failure instance indication is cell specific or cell level; and performing 903 in the case where the beam failure instance indication is not cell specific or cell level, otherwise jumping to A, and performing the operation of FIG. 10;
903, starting or restarting a transmission reception point (TRP)-specific beam failure detection timer (e.g., beamFailure DetectionTimer-perTRP);
904, incrementing 1 to the TRP-specific beam failure indication count associated with the TRP-specific beam failure detection timer (e.g., beamFailureDetectionTimer-per TRP);
905, determining whether the TRP-specific beam failure indication count (e.g., BFI_COUNTER-perTRP) is greater than or equal to the TRP-specific beam failure instance maximum count (e.g., beamFailureInstanceMaxCount-perTRP); and
906, in a case where the TRP-specific beam failure indication count (e.g., BFI_COUNTER-perTRP) is greater than or equal to the TRP-specific beam failure instance maximum count (e.g., beamFailureInstanceMaxCount-perTRP), determining that a beam failure of the TRP is detected or a beam failure recovery (BFR) of the TRP is triggered or a beam failure indication of the TRP is triggered.

As shown in FIG. 9, the operation of the MAC entity further includes:
907, determining whether the TRP-specific beam failure detection timer (e.g., beamFailureDetectionTimer-perTRP) has expired; and
908, resetting the TRP-specific beam failure indication count (e.g., BFI_COUNTER-perTRP) or setting the TRP-specific beam failure indication count (e.g., BFI_COUNTER-perTRP) to 0 in the case where the TRP-specific beam failure detection timer has expired.

It should be noted that FIG. 9 only schematically illustrates the embodiment of the present application, but the present application is not limited thereto. For example, the execution order between the operations may be appropriately adjusted, and some other operations may be added or some of the operations may be reduced. And appropriate variants may be made by those skilled in the art according to the above contents, which are not limited to the description of FIG. 9 described above.

FIG. 10 is another schematic diagram of a method for detecting beam failure according to an embodiment of the present application, schematically illustrating an operation of an MAC entity of a terminal equipment. As shown in FIG. 10, the operation of the MAC entity includes:
1001, starting or restarting a cell-specific beam failure detection timer (e.g., beamFailure DetectionTimer-perCell or beamFailureDetectionTimer);
1002, incrementing 1 to the cell-specific beam failure indication count (e.g., FI_COUNTER-perCell or BFI_COUNTER) associated with the cell-specific beam failure detection timer (e.g., beamFailureDetectionTimer-perCell or beamFailureDetectionTimer);
1003, determining whether the cell-specific beam failure indication count (e.g., BFI_COUNTER-perCell or BFI_COUNTER) is greater than or equal to the cell-specific beam failure instance maximum count (e.g., beamFailure InstanceMaxCount-perCell or beamFailure InstanceMaxCount); and
1004, in a case where the cell-specific beam failure indication count (e.g., BFI_COUNTER-perCell or BFI_COUNTER) is greater than or equal to the cell-specific beam failure instance maximum count (e.g., beamFailure InstanceMaxCount-perCell or beamFailureInstanceMaxCount), determining that a beam failure of the cell is detected or a beam failure recovery (BFR) of the cell is triggered or a beam failure indication of the cell is triggered.

As shown in FIG. 10, the operation of the MAC entity further includes:
1005, determining whether the cell-specific beam failure detection timer (e.g., beamFailure DetectionTimer-perCell or beamFailureDetectionTimer) has expired; and
1006, resetting the cell-specific beam failure indication count (e.g., BFI_COUNTER-perCell or BFI_COUNTER) or setting the cell-specific beam failure indication count (e.g., BFI_COUNTER-perCell or BFI_COUNTER) to 0 in the case where the cell-specific beam failure detection timer has expired.

It should be noted that FIG. 10 only schematically illustrates the embodiment of the present application, but the present application is not limited thereto. For example, the execution order between the operations may be appropriately adjusted, and some other operations may be added or some of the operations may be reduced. And appropriate variants may be made by those skilled in the art according to the above contents, which are not limited to the description of FIG. 10 described above.

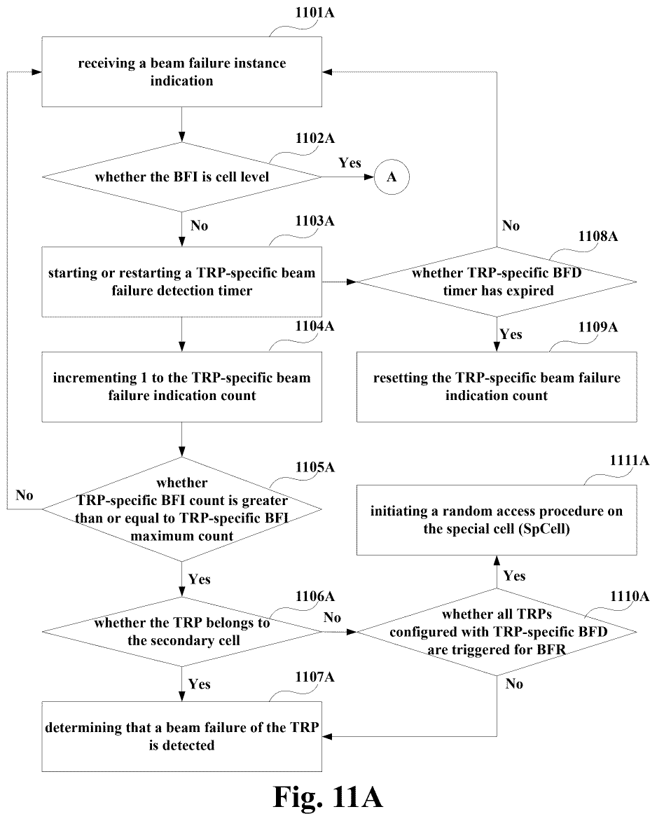

FIG. 11A is another schematic diagram of a method for detecting beam failure according to an embodiment of the present application, schematically illustrating an operation of an MAC entity of a terminal equipment. As shown in FIG. 11A, the operation of the MAC entity includes:
1101A, receiving a beam failure instance indication from a lower layer;
1102A, determining whether the beam failure instance indication is cell specific or cell level; and performing 1103A in the case where the beam failure instance indication is not cell specific or cell level, otherwise jumping to A, and performing the operation of FIG. 10;
1103A, starting or restarting a transmission reception point (TRP)-specific beam failure detection timer (e.g., beamFailure DetectionTimer-perTRP);
1104A, incrementing 1 to the TRP-specific beam failure indication count (e.g. BFI_COUNTER-perTRP) associated with the TRP-specific beam failure detection timer (e.g., beamFailure DetectionTimer-per TRP);
1105A, determining whether the TRP-specific beam failure indication count (e.g., BFI_COUNTER-perTRP) is greater than or equal to the TRP-specific beam failure instance maximum count (e.g., beamFailureInstanceMaxCount-perTRP); and performing 1106A if the TRP-specific beam failure indication count (e.g., BFI_COUNTER-perTRP) is greater than or equal to the TRP-specific beam failure instance maximum count (e.g., beamFailureInstanceMaxCount-per TRP);
1106A, determining whether the TRP belongs to the secondary cell (SCell); and performing 1107A if the TRP belongs to the secondary cell (SCell) and performing 1110A if the TRP does not belong to the secondary cell (SCell);
1107A, determining that a beam failure of the TRP is detected or a beam failure recovery (BFR) of the TRP is triggered or a beam failure indication of the TRP is triggered.

As shown in FIG. 11A, the operation of the MAC entity further includes:
1108A, determining whether the TRP-specific beam failure detection timer (e.g., beamFailure DetectionTimer-perTRP) has expired; and performing 1109A in the case where the TRP-specific beam failure detection timer has expired;
1109A, resetting the TRP-specific beam failure indication count (e.g., BFI_COUNTER-per TRP) or setting the TRP-specific beam failure indication count (e.g., BFI_COUNTER-per TRP) to 0.

As shown in FIG. 11A, the operation of the MAC entity further includes:
1110A, determining whether all TRPs configured with TRP-specific beam failure detection are triggered for beam failure recovery; performing 1111A in the case where all TRPs configured with TRP-specific beam failure detection are triggered for beam failure recovery, otherwise performing 1107A;
1111A, initiating a random access procedure on the special cell (SpCell).

It should be noted that FIG. 11A only schematically illustrates the embodiment of the present application, but the present application is not limited thereto. For example, the execution order between the operations may be appropriately adjusted, and some other operations may be added or some of the operations may be reduced. And appropriate variants may be made by those skilled in the art according to the above contents, which are not limited to the description of FIG. 11A described above.

FIG. 11B is another schematic diagram of a method for detecting beam failure according to an embodiment of the present application, schematically illustrating an operation of an MAC entity of a terminal equipment. As shown in FIG. 11B, the operation of the MAC entity includes:
1101B, receiving a beam failure instance indication from a lower layer;
1102B, determining whether the beam failure instance indication is cell specific or cell level; and performing 1103B in the case where the beam failure instance indication is not cell specific or cell level, otherwise jumping to A, and performing the operation of FIG. 10;
1103B, starting or restarting a transmission reception point (TRP)-specific beam failure detection timer (e.g., beamFailure DetectionTimer-perTRP);
1104B, incrementing 1 to the TRP-specific beam failure indication count (e.g. BFI_COUNTER-perTRP) associated with the TRP-specific beam failure detection timer (e.g., beamFailureDetectionTimer-per TRP);
1105B, determining whether the TRP-specific beam failure indication count (e.g., BFI_COUNTER-perTRP) is greater than or equal to the TRP-specific beam failure instance maximum count (e.g., beamFailureInstanceMaxCount-perTRP); and performing 1106B if the TRP-specific beam failure indication count (e.g., BFI_COUNTER-perTRP) is greater than or equal to the TRP-specific beam failure instance maximum count (e.g., beamFailureInstance MaxCount-per TRP);
1106B, determining whether the TRP-specific beam failure is detected or TRP-specific BFR is triggered at multiple TRPs; and performing 1107B if not, and performing 1110B if yes;

The multiple TRPs include all TRPs configured with TRP-specific beam failure detection of all serving cells in the MAC entity, or all TRPs configured with TRP-specific beam failure detection of a special cell in the MAC entity.
1107B, determining that a beam failure of the TRP is detected or a beam failure recovery (BFR) of the TRP is triggered or a beam failure indication of the TRP is triggered.

As shown in FIG. 11B, the operation of the MAC entity further includes:
1108B, determining whether the TRP-specific beam failure detection timer (e.g., beamFailure DetectionTimer-perTRP) has expired; and performing 1109B in the case where the TRP-specific beam failure detection timer has expired;
1109B, resetting the TRP-specific beam failure indication count (e.g., BFI_COUNTER-perTRP) or setting the TRP-specific beam failure indication count (e.g., BFI_COUNTER-perTRP) to 0.

As shown in FIG. 11B, the operation of the MAC entity further includes:
1110B, initiating a random access procedure on the special cell (SpCell).

It should be noted that FIG. 11B only schematically illustrates the embodiment of the present application, but the present application is not limited thereto. For example, the execution order between the operations may be appropriately adjusted, and some other operations may be added or some of the operations may be reduced. And appropriate variants may be made by those skilled in the art according to the above contents, which are not limited to the description of FIG. 11B described above.

In some embodiments, as long as a TRP-specific BFR is configured, a cell-specific BFD on a specific cell should be configured, or a cell-specific BFD on a belonging cell should be configured or a cell-specific BFD on at least one cell should be configured.

The above embodiments merely exemplify the embodiments of the present application, but the present application is not limited thereto, and appropriate variants may be made on the basis of the above embodiments. For example, each of the above embodiments may be used alone or in combination with one or more of the above embodiments.

It can be known from the above embodiments, the MAC entity of the terminal equipment receives a beam failure instance indication, increments a transmission reception point (TRP)-specific beam failure indication count by 1, and in a case where the TRP-specific beam failure indication count is greater than or equal to a TRP-specific beam failure instance maximum count, determines that a beam failure occurs in a transmission reception point or beam failure recovery (BFR) of the transmission reception point is triggered or a beam failure indication of the transmission reception point is triggered. Thus, not only beam failure detection at the TRP level can be triggered when only part of the beams fails, but also beam failure detection at the cell level or the TRP level can be distinguished, thereby avoiding resource waste.

### Embodiments of the Third Aspect

The following description is based on the embodiments of the first and second aspects, and the same contents as the embodiments of the first and second aspects are not repeated. The embodiments of the third aspect may be performed separately or in combination with the embodiments of the first and second aspects; and in addition, the embodiments of the third aspect may be applicable to TRP-specific BFR/BFD as well as cell-specific BFR/BFD, such as Rel-16 BFR/BFD.

In some embodiments, a medium access control (MAC) entity of a terminal equipment detects that a beam failure occurs in a transmission reception point or a cell, or that the beam failure recovery (BFR) of the transmission reception point or the cell is triggered, or that beam failure indication of the transmission reception point or the cell is triggered; and the MAC entity of the terminal equipment instructs the multiplexing and assembly entity to generate a beam failure recovery MAC CE or a beam failure MAC CE.

In some embodiments, the MAC entity of the terminal equipment determines whether the evaluation of the candidate beam is completed when the candidate beam is configured. For example, completion of subsequent beam evaluation is considered only when candidate beams are configured and the MAC entity indicates generation (Truncated) BFR MAC CE.

In some embodiment, if the beam failure recovery procedure determines that at least one beam failure recovery has been triggered and is not cancelled, or a beam failure is detected, or at least one beam failure indication is triggered and is not cancelled, and if a candidate beam list is configured and evaluation of at least one reference signal in the candidate beam list has been completed, the MAC entity of the terminal equipment instructs the multiplexing and assemble entity to generate the beam failure recovery MAC CE or the beam failure MAC CE.

For example:
if the beam failure recovery procedure determines that at least one beam failure recovery has been triggered and is not cancelled, or a beam failure is detected, or at least one beam failure indication is triggered and is not cancelled, if a candidate beam is configured and evaluation of the candidate beam has been completed,
If the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
Otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
Otherwise, a scheduling request (SR) for beam failure recovery or beam failure is triggered for each cell or TRP for which a BFR is triggered and not cancelled if a candidate beam is configured and evaluation of the candidate beam has been completed.

For example, as described in Table 15 below:

TABLE 15
The MAC entity shall:

```
1>if the Beam Failure Recovery procedure determines that at least one BFR has been
  triggered and not cancelled for an SCell for which evaluation of the candidate beams,
  if configured, according to the requirements as specified in TS 38.133 [11] has been
  completed:
  2>if UL-SCH resources are available for a new transmission and if the UL-SCH
    resources can accommodate the BFR MAC CE plus its subheader as a result of
    LCP:
    3>instruct the Multiplexing and Assembly procedure to generate the BFR MAC
      CE.
  2>else if UL-SCH resources are available for a new transmission and if the UL-SCH
    resources can accommodate the Truncated BFR MAC CE plus its subheader as a
    result of LCP:
    3>instruct the Multiplexing and Assembly procedure to generate the Truncated
      BFR MAC CE.
  2>else:
  3>trigger the SR for SCell beam failure recovery for each SCell for which BFR has
    been triggered, not cancelled, and for which evaluation of the candidate beams
    according to the requirements as specified in TS 38.133 [11] has been completed.
```

In some embodiments, if the beam failure recovery procedure determines that at least one beam failure recovery has been triggered and is not cancelled, or a beam failure is detected, or at least one beam failure indication is triggered and is not cancelled, and if a candidate beam is not configured, the MAC entity of the terminal equipment does not determine whether the evaluation of the candidate beam is completed.

For example:
if the beam failure recovery procedure determines that at least one beam failure recovery has been triggered and is not cancelled, or a beam failure is detected, or at least one beam failure indication is triggered and is not cancelled, if a candidate beam is configured and evaluation of the candidate beam has been completed, or a candidate beam is not configured,
If the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
Otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
Otherwise, a scheduling request (SR) for the beam failure recovery or the beam failure is triggered for each cell or TRP that has triggered BFR and has not been cancelled.

For example, as described in Table 16 below:

TABLE 16
The MAC entity shall:

```
1>if the Beam Failure Recovery procedure determines that at least one BFR has been
  triggered and not cancelled for an SCell:
  2>if at least one candidate beam is configured, and if evaluation of the candidate
    beams according to the requirements as specified in TS 38.133 [11] has been
    completed for the BFR; or
  2> if candidate beam is not configured:
    3> if UL-SCH resources are available for a new transmission and if the UL-SCH
        resources can accommodate the BFR MAC CE plus its subheader as a result of
        LCP:
      4> instruct the Multiplexing and Assembly procedure to generate the BFR MAC
      CE.
    3>else if UL-SCH resources are available for a new transmission and if the UL-
      SCH resources can accommodate the Truncated BFR MAC CE plus its
      subheader as a result of LCP:
      4> instruct the Multiplexing and Assembly procedure to generate the Truncated
    BFR MAC CE.
    3> else:
    4> trigger the SR for SCell beam failure recovery for each SCell for which BFR
      has been triggered, not cancelled, and for which evaluation of the candidate
      beams according to the requirements as specified in TS 38.133 [11] has been
      completed.
```

In some embodiments, the MAC entity of the terminal equipment determines that the evaluation of the candidate beam has been completed if the candidate beam is not configured in the case where at least one beam failure recovery is triggered.

For example, as described in Table 17 below:

TABLE 17
The MAC entity shall for each Serving Cell configured for beam failure detection:

```
1>if beam failure instance indication has been received from lower layers:
  2>start or restart the beamFailureDetectionTimer;
  2>increment BFI_COUNTER by 1;
  2>if BFI_COUNTER >= beamFailureInstanceMaxCount:
    3>if the Serving Cell is SCell:
      4>trigger a BFR for this Serving Cell;
      4> if candidateBeamRSSCellList-r16 is not configured
      5> consider evaluation of the candidate beams according to the
        requirements as specified in TS 38.133 has been completed without any
        periodic CSI-RS configuration index or SS/PBCH block index
    3>else:
        4> initiate a Random Access procedure (see clause 5.1) on the SpCell.
```

In some embodiments, the physical layer of the terminal equipment, upon receiving the higher layer request, determines that the evaluation of the candidate beam has been completed in the case where the candidate beam is not configured.

For example, as described in Table 18 below:

TABLE 18
For the PCell or the PSCell, upon request from higher layers, the UE provides to higher
layers the periodic CSI-RS configuration indexes and/or SS/PBCH block indexes from the
set q̅₁, if configured and the corresponding L1-RSRP measurements that are larger than
or equal to the Q_{in,LR} threshold or the UE indicates that evaluation of the candidate
beams according to the requirements as specified in TS 38.133 has been completed
without any periodic CSI-RS configuration index or SS/PBCH block index if the set
q̅₁ is not configured.
For the SCell, upon request from higher layers, the UE indicates to higher layers that
evaluation of the candidate beams according to the requirements as specified in TS
38.133 has been completed without any periodic CSI-RS configuration index or
SS/PBCH block index if the set q̅₁ is not configured or whether there is at least one
periodic CSI-RS configuration index and/or SS/PBCH block index from the set q̅₁, if
configured, with corresponding L1-RSRP measurements that are larger than or equal to the
Q_{in, LR} threshold, and provides the periodic CSI-RS configuration indexes and/or SS/PBCH
block indexes from the set q̅₁ and the corresponding L1-RSRP measurements that are
larger than or equal to the Q_{in, LR} threshold, if any.

In some embodiments, in a case where a reference signal for beam failure detection is configured, a candidate reference signal is configured. For example, if a reference signal for beam failure detection is configured, a candidate reference signal should be configured.

For example, as described in Tables 19 to 21 below:

TABLE 19
BeamFailureRecoverySCellConfig
The IE BeamFailureRecoverySCellConfig is used to configure the UE with candidate
beams for beam failure recovery in case of beam failure detection in SCell. See also TS
38.321 [3], clause 5.x.x.
BeamFailureRecoverySCellConfig information element

-- ASN1START
-- TAG-BEAMFAILURERECOVERYSCELLCONFIG-START
BeamFailureRecoverySCellConfig-r16 ::= SEQUENCE {

| | |
|---|---|
| rsrp-ThresholdBFR-r16 | RSRP-Range |

OPTIONAL, -- Need M

| | |
|---|---|
| candidateBeamRSSCellList-r16 | SEQUENCE |

(SIZE(1..maxNrofCandidateBeams-r16)) OF CandidateBeamRS-r16 OPTIONAL, --
Cond BFD-RS

. . .

}

| | |
|---|---|
| CandidateBeamRS-r16 ::= | SEQUENCE { |

| | |
|---|---|
| candidateBeamConfig-r16 | CHOICE { |

| | |
|---|---|
| ssb-r16 | SSB-Index, |

| | |
|---|---|
| csi-RS-r16 | NZP-CSI-RS-ResourceId |

| }, | |
|---|---|
| servingCellId | ServCellIndex |

OPTIONAL -- Need R
}
-- TAG-BEAMFAILURERECOVERYSCELLCONFIG-STOP
-- ASN1STOP

TABLE 20
BeamFailureRecoverySCellConfig field descriptions

candidateBeamConfig
Indicates the resource (i.e. SSB or CSI-RS) defining this beam resource.
candidateBeamRSSCellList
A list of reference signals (CSI-RS and/or SSB) identifying the candidate beams for recovery.
The network always configures this parameter in every instance of this IE.
rsrp-ThresholdBFR
L1-RSRP threshold used for determining whether a candidate beam may be included by the
UE be in BFR MAC CE (see TS 38.213 [13], clause X). The network always configures this
parameter in every instance of this IE.
servingCellId
If the field is absent, the RS belongs to the serving cell in which this
BeamFailureSCellRecoveryConfig is configured

TABLE 21

| Conditional | |
|---|---|
| Presence | Explanation |
| BFD-RS | The field is mandatory present if the |
| | radioLinkMonitoringRS-Id associated purpose |
| | is “beamFailure” or “both” is configured in the |
| | RadioLinkMonitoringConfig; else, the field absent.is |

In some embodiments, for each cell/TRP configured with beam failure recovery or with beam failure recovery parameters, and/or configured with beam failure detection or with beam failure detection parameters, the MAC entity will determine whether to instruct generation of an MAC CE or trigger an SR.

For example, for each cell/TRP configured with beam failure recovery or with beam failure recovery parameters, and/or configured with beam failure detection or with beam failure detection parameters, the MAC entity will,
if the beam failure recovery procedure determines that at least one beam failure recovery has been triggered and is not cancelled, or a beam failure is detected, or at least one beam failure indication is triggered and is not cancelled, and evaluation of the candidate beam has been completed,
If the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
Otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
Otherwise, a scheduling request (SR) for the beam failure recovery or the beam failure is triggered for each cell or TRP that has triggered BFR and has not been cancelled.

In some embodiments, for each cell/TRP configured with beam failure recovery or with beam failure recovery parameters, and/or configured with beam failure detection or with beam failure detection parameters, the MAC entity will perform beam failure detection to trigger the BFR.

For example, a cell-specific beam failure detection is taken as an example:
for each serving cell configured with beam failure detection (or configured with beam failure detection parameters), and/or configured with beam failure recovery (or configured with beam failure recovery parameters), the MAC entity will:
if a beam failure instance indication has been received from the lower layer:
start or restart the beam failure detection timer beamFailureDetectionTimer;
increment 1 to the UE variable BFI_COUNTER;
if BFI_COUNTER is greater than or equal to the beam failure instance maximum count value beamFailure InstanceMax Count:
trigger a BFR for this serving cell if the serving cell is a secondary cell (SCell);
otherwise, initiate a random access procedure on this special cell (SpCell).

For another example, a cell-specific beam failure detection is taken as an example:
for each serving cell configured with beam failure detection (or configured with beam failure detection parameters), and/or configured with beam failure recovery (or configured with beam failure recovery parameters), the MAC entity will:
if a beam failure instance indication has been received from the lower layer:
start or restart the beam failure detection timer beamFailureDetectionTimer perTRP;
increment 1 to the UE variable BFI_COUNTER_perTRP;
if BFI_COUNTER perTRP is greater than or equal to the beam failure instance maximum count value beamFailure InstanceMaxCount perTRP:
trigger a BFR of the TRP if the TRP belongs to a secondary cell (SCell), or all other TRPs of the serving cell that are configured with the TRP-specific beam failure detection are not triggered BFR;
otherwise, initiate a random access procedure on this special cell (SpCell).

The operation of the MAC entity is schematically described above, and embodiments of the present application are not limited thereto. Furthermore, the beam failure recovery parameters described above may be replaced with specific parameters, such as one or more of the following parameters:
BeamFailureRecoveryConfig,
BeamFailureRecoverySCellConfig,
BeamFailureRecoveryConfig-TRP,
candidateBeamRSList,
candidateBeamRSSCellList,
candidateBeamRSList-TRP.

The above embodiments merely exemplify the embodiments of the present application, but the present application is not limited thereto, and appropriate variants may be made on the basis of the above embodiments. For example, each of the above embodiments may be used alone or in combination with one or more of the above embodiments.

### Embodiments of the Fourth Aspect

The embodiments of the present application provide an apparatus for detecting beam failure. The apparatus may be, for example, a terminal device or may be a certain or some parts or components configured in the terminal device, and the same content as the embodiments of the first to third aspects will not be described in detail.

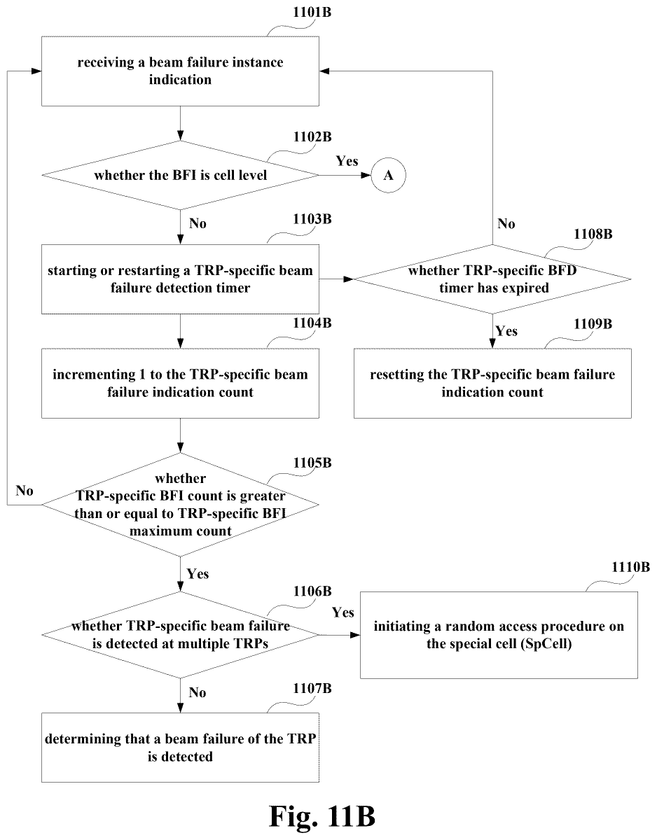

FIG. 12 is a schematic diagram of an apparatus for detecting beam failure according to an embodiment of the present application. As shown in FIG. 12, the apparatus 1200 for detecting beam failure includes:
a receiving unit 1201 configured to receive a beam failure instance indication by a medium access control (MAC) entity;
a counting unit 1202 configured to increment a TRP-specific beam failure indication count by 1; and
a processing unit 1203 configured to, in a case where the TRP-specific beam failure indication count is greater than or equal to a TRP-specific beam failure instance maximum count, determine that a beam failure occurs in a transmission reception point or beam failure recovery (BFR) of the transmission reception point is triggered or a beam failure indication of the transmission reception point is triggered.

In some embodiments, as shown in FIG. 12, the apparatus 1200 for detecting beam failure further includes:
a starting unit 1204 configured to start or restart a transmission reception point (TRP)-specific beam failure detection timer when the medium access control entity receives a beam failure instance indication;
reset the TRP-specific beam failure indication count or set the TRP-specific beam failure indication count to 0 in the case where the TRP-specific beam failure detection timer has expired. In some embodiments, the MAC entity of the terminal equipment instructs the multiplexing and assembly entity to generate a TRP-specific beam failure recovery MAC CE or a TRP-specific beam failure MAC CE.

In some embodiments, the MAC entity of the terminal equipment determines whether the evaluation of the candidate beam is completed when the candidate beam is configured.

In some embodiment, if the beam failure recovery procedure determines that at least one beam failure recovery has been triggered and is not cancelled, or a beam failure is detected, or at least one beam failure indication is triggered and is not cancelled, and if a candidate beam list is configured and evaluation of at least one reference signal in the candidate beam list has been completed, the MAC entity of the terminal equipment instructs the multiplexing and assemble entity to generate the TRP-specific beam failure recovery MAC CE or the TRP-specific beam failure MAC CE.

For example:
if the beam failure recovery procedure determines that at least one beam failure recovery has been triggered and is not cancelled, or a beam failure is detected, or at least one beam failure indication is triggered and is not cancelled, and if a candidate beam is configured and evaluation of the candidate beam has been completed,
if the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
otherwise, a scheduling request (SR) for the TRP-specific beam failure recovery or the TRP-specific beam failure is triggered for each TRP that has triggered a BFR and has not been cancelled.

In some embodiments, if the beam failure recovery procedure determines that at least one beam failure recovery has been triggered and is not cancelled, or a beam failure is detected, or at least one beam failure indication is triggered and is not cancelled, and if a candidate beam list is not configured, the MAC entity of the terminal equipment does not determine whether the evaluation of the candidate beam is completed.

For example:
if the beam failure recovery procedure determines that at least one beam failure recovery has been triggered and is not cancelled, or a beam failure is detected, or at least one beam failure indication is triggered and is not cancelled,
if a candidate beam is configured and evaluation of the candidate beam has been completed, or if a candidate beam is not configured,
if the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
otherwise, a scheduling request (SR) for the TRP-specific beam failure recovery or the TRP-specific beam failure is triggered for each TRP that has triggered a BFR and has not been cancelled.

For another example,
if the beam failure recovery procedure determines that at least one beam failure recovery has been triggered and is not cancelled, or a beam failure is detected, or at least one beam failure indication is triggered and is not cancelled,
if a candidate beam is not configured,
if the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
otherwise, a scheduling request (SR) for the TRP-specific beam failure recovery or the TRP-specific beam failure is triggered for each TRP that has triggered a BFR and has not been cancelled.

In some embodiments, the MAC entity of the terminal equipment determines that the evaluation of the candidate beam has been completed if the candidate beam is not configured in the case where at least one beam failure recovery is triggered.

In some embodiments, the physical layer of the terminal equipment, upon receiving the higher layer request, determines that the evaluation of the candidate beam has been completed in the case where the candidate beam is not configured.

In some embodiments, in a case where a reference signal for beam failure detection is configured, a candidate reference signal is configured.

In some embodiments, some or all of the serving cells in the MAC entity of the terminal equipment are configure with TRP-specific beam failure detection, and/or, a special cell in the MAC entity of the terminal equipment is configured with the TRP-specific beam failure detection.

In some embodiments, all of the serving cells in the MAC entity of the terminal equipment do not configured with cell-specific beam failure detection, or, a special cell in the MAC entity of the terminal equipment does not configured with the cell-specific beam failure detection. In a case where TRP-specific beam failure is detected or TRP-specific beam failure recovery is triggered at multiple TRPs, the MAC entity of the terminal equipment initiates a random access procedure in the special cell.

The multiple TRPs include all TRPs configured with TRP-specific beam failure detection of all serving cells in an MAC entity, or all TRPs configured with TRP-specific beam failure detection of a special cell in an MAC entity.

In some embodiments, the MAC entity of the terminal equipment determines whether the transmission reception point belongs to a secondary cell; and in a case where the transmission reception point belongs to a secondary cell, determines that a beam failure occurs in the transmission reception point or beam failure recovery of the transmission reception point is triggered or a beam failure indication of the transmission reception point is triggered.

In some embodiments, the MAC entity of the terminal equipment determines whether all TRPs configured with TRP-specific beam failure detection are triggered for beam failure recovery; in the case where all TRPs configured with TRP-specific beam failure detection are triggered for beam failure recovery, the MAC entity of the terminal equipment initiates a random access procedure in the special cell.

In some embodiments, the terminal equipment performs one or any combination of the following:
in the case where the terminal equipment transmits an MAC PDU and the MAC PDU includes a TRP-specific beam failure recovery MAC CE or a TRP-specific beam failure MAC CE, the terminal equipment cancels all of the beam failure recovery triggered for the TRPs before assembly of the MAC PDU;
or in the case where the terminal equipment transmits an MAC PDU, and the MAC PDU includes a beam failure recovery MAC CE or a truncated beam failure recovery MAC CE, and the MAC CE includes beam failure information of a cell, the MAC entity of the terminal equipment cancels all of the beam failure recovery triggered for all TRPs included in the cell before assembly of the MAC PDU;
or if a PDCCH addressed by the C-RNTI indicates receipt of uplink grant for a new transmission of a HARQ process for transmission including a TRP-specific beam failure recovery MAC CE or a TRP-specific beam failure MAC CE, the MAC entity of the terminal equipment cancels all beam failure recovery triggered for the TRP;
or if a PDCCH addressed by the C-RNTI indicates receipt of uplink grant for a new transmission of a HARQ process for transmission including a beam failure recovery MAC CE or a truncated beam failure recovery MAC CE of beam failure information of a cell, the MAC entity of the terminal equipment cancels all beam failure recovery triggered for all TRPs included in the cell.

In some embodiments, the terminal equipment triggers a scheduling request (SR) for the TRP-specific beam failure recovery or the TRP-specific beam failure, for a TRP that has triggered a BFR and has not been cancelled.

In some embodiments, the scheduling request configures a SR ID or a set of SR IDs.

In some embodiments, the configuration value of the TRP-specific beam failure recovery SR ID is the same as the configuration value of the cell-specific beam failure recovery SR ID, or the configuration value of the TRP-specific beam failure recovery SR ID is different from the configuration value of the cell-specific beam failure recovery SR ID.

In some embodiments, the configuration values of the TRP-specific beam failure recovery SR ID and the control resource pool index are the same as the configuration value of the cell-specific beam failure recovery SR ID, or the configuration values of the TRP-specific beam failure recovery SR ID and the control resource pool index are different from the configuration value of the cell-specific beam failure recovery SR ID.

In some embodiments, when an MAC entity of a terminal equipment has a pending SR for a TRP-specific BFR, and for an SR transmission occasion, the MAC entity has one or more PUCCH resources overlapping with PUCCH resources of the TRP-specific BFR, the MAC entity determines (deems) that the PUCCH resources of the TRP-specific BFR are valid; or

When an MAC entity of a terminal equipment has a pending SR for a secondary cell/TRP-specific BFR, and for an SR transmission occasion, the MAC entity has one or more PUCCH resources overlapping with PUCCH resources of the secondary cell/TRP-specific BFR, the MAC entity determines (deems) that the PUCCH resources of the secondary cell/TRP-specific BFR are valid.

In some embodiments,
in the case where the terminal equipment transmits an MAC PDU and the MAC PDU includes a beam failure recovery MAC CE or a truncated beam failure recovery MAC CE, the beam failure recovery MAC CE or the truncated beam failure recovery MAC CE includes beam failure information of a cell, the MAC entity of the terminal equipment cancels the pending SR triggered for the BFR of the TRP included in the cell and stops the respective prohibiting timer;
or, in the case where the terminal equipment transmits an MAC PDU, and the MAC PDU includes an MAC CE that includes beam failure information for a TRP, the MAC entity of the terminal equipment cancels the pending SR triggered for the BFR of the TRP and stops the respective prohibiting timer;
or once a secondary cell is deactivated, the MAC entity of the terminal equipment cancels the pending SR triggered for the BFR of the TRP included in the secondary cell;
or the MAC entity of the terminal equipment cancels the triggered pending SR if all TRP-specific BFRs of the triggered SR are cancelled;
or upon SR resource reconfiguration, the MAC entity of the terminal equipment cancels the pending SR.

In some embodiments, in the case where an MAC PDU performs transmission using an uplink grant except an uplink grant provided by random access response (RAR) or an uplink grant determined from the transmission of the message A payload (MSGA payload), and the MAC PDU includes an MAC CE including beam failure information of a TRP, the MAC entity of the terminal equipment stops the ongoing random access procedure due to the pending SR for the BFR of the TRP.

In some embodiments, the MAC entity of the terminal equipment determines whether the beam failure instance indication is cell specific or cell level; and in the case where the beam failure instance indication is not cell specific or cell level, starts or restarts a transmission reception point (TRP)-specific beam failure detection timer.

In some embodiments, the MAC entity of the terminal equipment determines whether the beam failure instance indication is TRP specific or TRP level; and in the case where the beam failure instance indication is TRP specific or TRP level, starts or restarts the transmission reception point (TRP)-specific beam failure detection timer.

In some embodiments, in the case where the beam failure instance indicates whether it is cell specific or cell level, or not TRP specific or TRP level, a cell-specific beam failure detection timer is started or restarted;
a cell-specific beam failure indication count is incremented by 1; and
in a case where the cell-specific beam failure indication count is greater than or equal to the cell-specific beam failure instance maximum count, it is determined that a beam failure of the cell is detected or a beam failure recovery of the cell is triggered or a beam failure indication of the cell is triggered.

In some embodiments, the cell-specific beam failure indication count is reset or the cell-specific beam failure indication count is set to 0 in the case where the TRP-specific beam failure detection timer has expired.

The above embodiments merely exemplify the embodiments of the present application, but the present application is not limited thereto, and appropriate modifications may be made on the basis of the above embodiments. For example, each of the above embodiments may be used alone or in combination with one or more of the above embodiments.

It should be noted that only the components or modules related to the present application have been described above, but the present application is not limited thereto. The apparatus 1200 for detecting beam failure may further include other components or modules, and related art may be referred to for details of these components or modules.

In addition, for the sake of simplicity, FIG. 12 exemplarily shows only the connection relationship or signal trend between the various components or modules, however, it should be clear to a person skilled in the art that various related techniques such as bus connection may be used. The various components or modules described above may be implemented by hardware facilities such as a processor, a memory, a transmitter, a receiver, etc.; implementation of the present application is not limited thereto.

It can be known from the above embodiments, the MAC entity of the terminal equipment receives a beam failure instance indication, increments a transmission reception point (TRP)-specific beam failure indication count by 1, and in a case where the TRP-specific beam failure indication count is greater than or equal to a TRP-specific beam failure instance maximum count, determines that a beam failure occurs in a transmission reception point or beam failure recovery (BFR) of the transmission reception point is triggered or a beam failure indication of the transmission reception point is triggered. Thus, not only beam failure detection at the TRP level can be triggered when only part of the beams fails, but also beam failure detection at the cell level or the TRP level can be distinguished, thereby avoiding resource waste.

### Embodiments of the Fifth Aspect

An embodiment of the present application further provides a communication system, which can refer to FIG. 1, and the same content as the embodiments of the first to fourth aspects will not be described in detail.

In some embodiments, the communication system may include:
a terminal equipment, configured to receive a beam failure instance indication by a medium access control (MAC) entity, increment a transmission reception point (TRP)-specific beam failure indication count by 1, and in a case where the TRP-specific beam failure indication count is greater than or equal to a TRP-specific beam failure instance maximum count, determine that a beam failure occurs in a transmission reception point or beam failure recovery (BFR) of the transmission reception point is triggered or a beam failure indication of the transmission reception point is triggered; and
a network device which receives a beam failure recovery MAC CE or a beam failure MAC CE.

An embodiment of the present application further provides a network device, which may be, for example, a base station, but the present application is not limited thereto, and may also be other network devices.

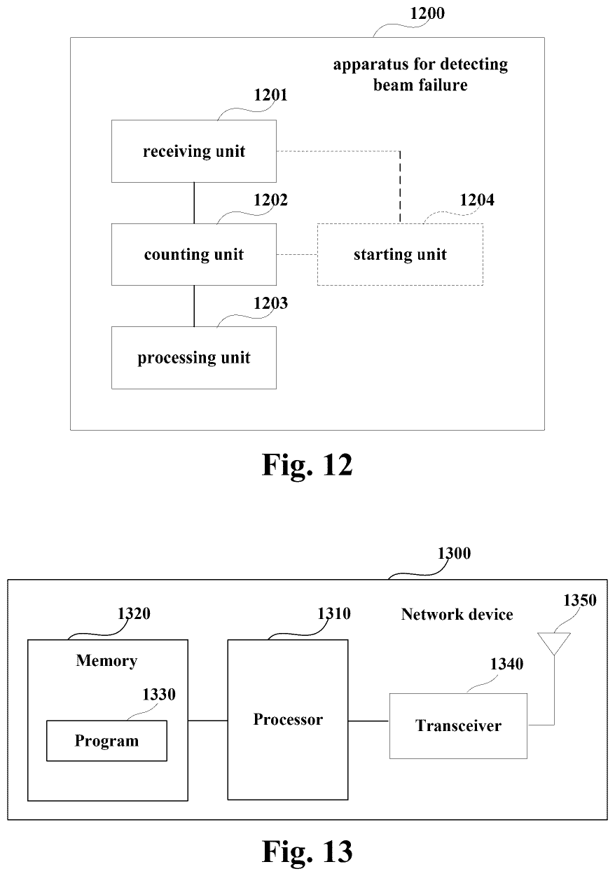

FIG. 13 is a configuration diagram of a network device according to an embodiment of the present application. As shown in FIG. 13, the network device 1300 may include a processor 1300 (such as a central processing unit (CPU)) and a memory 1320; the memory 1320 is coupled to the processor 1310. The memory 1320 can store various data; a program 1330 for information processing is also stored and the program 1330 is executed under the control of the processor 1310.

In addition, as shown in FIG. 13, the network device 1300 may further include a transceiver 1340 and an antenna 1350, etc.; the functions of the above-mentioned components are similar to those of the relevant art, and will not be described again here. It is worth noting that the network device 1300 is not necessarily required to include all of the components shown in FIG. 13; in addition, the network device 1300 may further include components not shown in FIG. 13, with reference to the relevant art.

An embodiment of the present application further provides a terminal device, but the present application is not limited thereto, and may also be other devices.

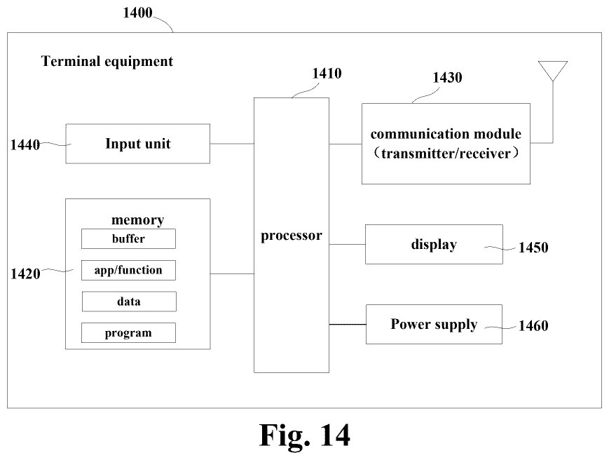

FIG. 14 is a schematic diagram of a terminal device according to an embodiment of the present application. As shown in FIG. 14, the terminal device 1400 may include a processor 1410 and a memory 1420; the memory 1420 stores data and program and is coupled to the processor 1410. It is worth noting that this figure is exemplary; other types of structures may also be used in addition to or instead of the structure to implement telecommunications functions or other functions.

For example, the processor 1410 may be configured to execute a program to implement the method for detecting beam failure as described in the embodiment of the first aspect. For example, the processor 1410 may be configured to perform the following controls: receiving a beam failure instance indication by a medium access control (MAC) entity; incrementing a transmission reception point (TRP)-specific beam failure indication count by 1; and in a case where the TRP-specific beam failure indication count is greater than or equal to a TRP-specific beam failure instance maximum count, determining that a beam failure occurs in a transmission reception point or beam failure recovery (BFR) of the transmission reception point is triggered or a beam failure indication of the transmission reception point is triggered.

For another example, the processor 1410 may be configured to execute a program to implement the method for detecting beam failure as described in the embodiment of the second aspect. For example, the processor 1410 may be configured to perform the following controls: receiving a beam failure instance indication by a medium access control (MAC) entity; determining whether the beam failure instance indication is TRP specific or TRP level; incrementing 1 to the TRP-specific beam failure indication count in the case where the beam failure instance indication is TRP specific or TRP level; and in a case where the TRP-specific beam failure indication count is greater than or equal to a maximum count of a TRP-specific beam failure instance, determining that a beam failure occurs in a transmission reception point or beam failure recovery (BFR) of the transmission reception point is triggered or a beam failure indication of the transmission reception point is triggered.

For example, the processor 1410 may be configured to execute a program to implement the method for detecting beam failure as described in the embodiment of the third aspect. For example, the processor 1410 may be configured to perform the following controls: detecting, by a medium access control (MAC) entity, that a beam failure occurs at a transmission reception point or in a cell or that the beam failure recovery (BFR) at the transmission reception point or in the cell is triggered or that beam failure indication of the transmission reception point or the cell is triggered; and instructing, by the MAC entity, the multiplexing and assembly entity to generate a beam failure recovery MAC CE or a beam failure MAC CE.

As shown in FIG. 14, the terminal device 1400 may further include a communication module 1430, an input unit 1440, a display 1450, and a power supply 1460. The functions of the above-mentioned components are similar to those of the relevant art, and will not be described again here. It is worth noting that the terminal device 1400 is not necessarily required to include all of the components shown in FIG. 14, and the above components are not necessary; in addition, the terminal device 1400 may further include components not shown in FIG. 14, with reference to the relevant art.

Embodiments of the present application further provide a computer program, wherein when the program is executed in a terminal device, the program causes the terminal device to execute the method for detecting beam failure as described in the embodiments of the first to third aspects. Embodiments of the present application further provide a storage medium in which a computer program is stored, wherein the computer program causes the terminal device to execute the method for detecting beam failure as described in the embodiments of the first to third aspects.

The above apparatus and method of the present application may be implemented by hardware, or may be implemented by hardware in combination with software. The present application relates to a computer-readable program that, when executed by a logic component, enables the logic component to implement the apparatus or constituent components described above, or enables the logic component to implement the various methods or steps described above. The present application also relates to a storage medium for storing the above program, such as a hard disk, a magnetic disk, an optical disk, a DVD, a flash memory, etc.

The method/apparatus described in connection with embodiments of the present application may be embodied directly in hardware, a software module executed by a processor, or a combination of both. For example, one or more of the functional blocks and/or one or more combinations of the functional blocks shown in the drawings may correspond to each software module or each hardware module of a computer program flow. These software modules may correspond to the respective steps shown in the drawings. The hardware modules may be implemented, for example, by solidifying the software modules using a field programmable gate array (FPGA).

A software module may be located in an RAM memory, a flash memory, an ROM memory, an EPROM memory, an EEPROM memory, a register, a hard disk, a removable disk, a CD-ROM, or any other form of storage medium known in the art. A storage medium may be coupled to the processor to enable the processor to read information from and write information to the storage medium, or the storage medium may be an integral part of the processor. The processor and the storage medium may reside in an ASIC. The software module may be stored in a memory of the mobile terminal or in a memory card insertable into the mobile terminal. For example, if the device (such as a mobile terminal) employs a large-capacity MEGA-SIM card or a large-capacity flash memory device, the software module can be stored in the MEGA-SIM card or the large-capacity flash memory device.

One or more of the functional blocks and/or one or more combinations of the functional blocks depicted in the accompanying drawings may be implemented as a general purpose processor, a digital signal processor (DSP), an application specific integrated circuit (ASIC), a field programmable gate array (FPGA) or other programmable logic devices, a discrete gate or a transistor logic device, a discrete hardware component, or any suitable combination thereof designed to perform the functions described in the present application. One or more of the functional blocks and/or one or more combinations of the functional blocks depicted in the accompanying drawings may also be implemented as combination of computing devices, e.g., combination of a DSP and a microprocessor, a plurality of microprocessors, one or more microprocessors in communication with the DSP, or any other such configuration.

The present application is described in combination with specific embodiments hereinabove, but a person skilled in the art should know clearly that the description is exemplary, but not limitation to the protection scope of the present application. A person skilled in the art can make various variations and modifications to the present application according to spirit and principle of the application, and these variations and modifications should also be within the scope of the present application.

Regarding the embodiments including the above embodiments, the following appendixes are also disclosed:

1. A method for detecting beam failure, including:
receiving a beam failure instance indication by a medium access control (MAC) entity of a terminal equipment;
incrementing a transmission reception point (TRP)-specific beam failure indication count by 1; and
in a case where the TRP-specific beam failure indication count is greater than or equal to a TRP-specific beam failure instance maximum count, determining that a beam failure occurs in a transmission reception point or beam failure recovery (BFR) of the transmission reception point is triggered or a beam failure indication of the transmission reception point is triggered.

2. The method according to the appendix 1, wherein the method further includes:
starting or restarting a transmission reception point (TRP)-specific beam failure detection timer when the medium access control (MAC) entity receives a beam failure instance indication;
resetting the TRP-specific beam failure indication count or setting the TRP-specific beam failure indication count to 0 in the case where the TRP-specific beam failure detection timer has expired.

3. The method according to the appendix 1 or 2, wherein the method further includes:
instructing, by the MAC entity of the terminal equipment, the multiplexing and assembly entity to generate a TRP-specific beam failure recovery MAC CE or a TRP-specific beam failure MAC CE.

4. The method according to the appendix 3, wherein the MAC entity of the terminal equipment determines whether evaluation of the candidate beam is completed only when the candidate beam is configured.

5. The method according to the appendix 3 or 4, wherein, if the beam failure recovery procedure determines that at least one beam failure recovery has been triggered and is not cancelled, or a beam failure is detected, or at least one beam failure indication is triggered and is not cancelled, and if a candidate beam list is configured and evaluation of at least one reference signal in the candidate beam list has been completed, the MAC entity of the terminal equipment instructs the multiplexing and assemble entity to generate the TRP-specific beam failure recovery MAC CE or the TRP-specific beam failure MAC CE.

6. The method according to the appendix 3 or 4, wherein,
if the beam failure recovery procedure determines that at least one beam failure recovery has been triggered and is not cancelled, or a beam failure is detected, or at least one beam failure indication is triggered and is not cancelled, and if a candidate beam is configured and evaluation of the candidate beam has been completed,
if the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
otherwise, a scheduling request (SR) for the TRP-specific beam failure recovery or the TRP-specific beam failure is triggered for each TRP that has triggered a BFR and has not been cancelled.

7. The method according to the appendix 3 or 4, wherein, if the beam failure recovery procedure determines that at least one beam failure recovery has been triggered and is not cancelled, or a beam failure is detected, or at least one beam failure indication is triggered and is not cancelled, and if a candidate beam list is not configured, the MAC entity of the terminal equipment does not determine whether the evaluation of the candidate beam is completed.

8. The method according to the appendix 3 or 4, wherein,
if the beam failure recovery procedure determines that at least one beam failure recovery has been triggered and is not cancelled, or a beam failure is detected, or at least one beam failure indication is triggered and is not cancelled,
if a candidate beam is configured and evaluation of the candidate beam has been completed, or if a candidate beam is not configured,
if the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
otherwise, a scheduling request (SR) for the TRP-specific beam failure recovery or the TRP-specific beam failure is triggered for each TRP that has triggered a BFR and has not been cancelled.

9. The method according to the appendix 3 or 4, wherein,
if the beam failure recovery procedure determines that at least one beam failure recovery has been triggered and is not cancelled, or a beam failure is detected, or at least one beam failure indication is triggered and is not cancelled,
and if a candidate beam is not configured,
if the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
otherwise, a scheduling request (SR) for the TRP-specific beam failure recovery or the TRP-specific beam failure is triggered for each TRP that has triggered a BFR and has not been cancelled.

10. The method according to any of the appendixes 1 to 3, wherein the TRP is configured with beam failure recovery or with beam failure recovery parameters, and/or the TRP is configured with beam failure detection or with beam failure detection parameters;
for each TRP configured with beam failure recovery or with beam failure recovery parameters, and/or configured with beam failure detection or with beam failure detection parameters, the MAC entity will determine whether to instruct generation of an MAC CE or trigger a scheduling request (SR).

11. The method according to any of the appendixes 1 or 3, wherein,
for each TRP configured with beam failure recovery or with beam failure recovery parameters, and/or configured with beam failure detection or with beam failure detection parameters, the MAC entity performs the following operations:
if the beam failure recovery procedure determines that at least one beam failure recovery has been triggered and is not cancelled, or a beam failure is detected, or at least one beam failure indication is triggered and is not cancelled, and evaluation of the candidate beam has been completed,
if the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
otherwise, a scheduling request (SR) for the beam failure recovery or the beam failure is triggered for each TRP that has triggered a BFR and has not been cancelled.

12. The method according to any of the appendixes 1 to 3, wherein the TRP is configured with beam failure recovery or with beam failure recovery parameters, and/or the TRP is configured with beam failure detection or with beam failure detection parameters;
for each TRP configured with beam failure recovery or with beam failure recovery parameters, and/or configured with beam failure detection or with beam failure detection parameters, the MAC entity will perform beam failure detection to trigger the BFR.

13. The method according to any of the appendixes 1 to 12, wherein the method further includes:
the MAC entity of the terminal equipment determines that the evaluation of the candidate beam has been completed if the candidate beam is not configured in the case where at least one beam failure recovery is triggered.

14. The method according to any of the appendixes 1 to 12, wherein the method further includes:
the physical layer of the terminal equipment, upon receiving the higher layer request, determines that the evaluation of the candidate beam has been completed in the case where the candidate beam is not configured.

15. The method according to any of the appendixes 1 to 12, wherein in a case where a reference signal for beam failure detection is configured, a candidate reference signal is configured.

16. The method according to any of the appendixes 1 to 15, wherein some or all of the serving cells in the MAC entity of the terminal equipment are configured with TRP-specific beam failure detection, and/or, a special cell in the MAC entity of the terminal equipment is configured with the TRP-specific beam failure detection.

17. The method according to the appendix 16, wherein all of the serving cells in the MAC entity of the terminal equipment do not configured with cell-specific beam failure detection, or, a special cell in the MAC entity of the terminal equipment does not configured with the cell-specific beam failure detection; the method further includes:
in a case where TRP-specific beam failure is detected or TRP-specific beam failure recovery is triggered at multiple TRPs, the MAC entity of the terminal equipment initiates a random access procedure in the special cell.

18. The method according to the appendix 17, wherein, the multiple TRPs include: all TRPs configured with TRP-specific beam failure detection of all serving cells in one MAC entity, or all TRPs configured with TRP-specific beam failure detection of a special cell in one MAC entity.

19. The method according to any of the appendixes 1 to 18, wherein the method further includes:
determining, by the MAC entity of the terminal equipment, whether the transmission reception point belongs to a secondary cell; and
in a case where the transmission reception point belongs to a secondary cell, determining that a beam failure occurs in the transmission reception point or beam failure recovery of the transmission reception point is triggered or a beam failure indication of the transmission reception point is triggered.

20. The method according to the appendix 19, wherein the method further includes:
the MAC entity of the terminal equipment determines whether all TRPs configured with TRP-specific beam failure detection are triggered for beam failure recovery;
in the case where all TRPs configured with TRP-specific beam failure detection are triggered for beam failure recovery, the MAC entity of the terminal equipment initiates a random access procedure in the special cell.

21. The method according to any of the appendixes 1 to 20, wherein the method further includes one or any combination of the following operations:
in the case where the terminal equipment transmits an MAC PDU and the MAC PDU includes a TRP-specific beam failure recovery MAC CE or a TRP-specific beam failure MAC CE, the terminal equipment cancels all of the beam failure recovery triggered for the TRPs before assembly of the MAC PDU;
or in the case where the terminal equipment transmits an MAC PDU, and the MAC PDU includes a beam failure recovery MAC CE or a truncated beam failure recovery MAC CE, and the MAC CE includes beam failure information of a cell, the MAC entity of the terminal equipment cancels all of the beam failure recovery triggered for all TRPs included in the cell before assembly of the MAC PDU;
or if a PDCCH addressed by the C-RNTI indicates receipt of uplink grant for a new transmission of a HARQ process for transmission including a TRP-specific beam failure recovery MAC CE or a TRP-specific beam failure MAC CE, the MAC entity of the terminal equipment cancels all beam failure recovery triggered for the TRP;
or if a PDCCH addressed by the C-RNTI indicates receipt of uplink grant for a new transmission of a HARQ process for transmission including a beam failure recovery MAC CE or a truncated beam failure recovery MAC CE of beam failure information of a cell, the MAC entity of the terminal equipment cancels all beam failure recovery triggered for all TRPs included in the cell.

22. The method according to any of the appendixes 1 to 21, wherein the method further includes:
the terminal equipment triggers a scheduling request (SR) for the TRP-specific beam failure recovery or the TRP-specific beam failure, for a TRP that has triggered a BFR and has not been cancelled.

23. The method according to the appendix 22, wherein the scheduling request configures a SR ID or a set of SR IDs.

24. The method according to the appendix 23, wherein the configuration value of the TRP-specific beam failure recovery SR ID is the same as the configuration value of the cell-specific beam failure recovery SR ID, or the configuration value of the TRP-specific beam failure recovery SR ID is different from the configuration value of the cell-specific beam failure recovery SR ID.

25. The method according to the appendix 23, wherein the configuration values of the TRP-specific beam failure recovery SR ID and the control resource pool index are the same as the configuration value of the cell-specific beam failure recovery SR ID, or the configuration values of the TRP-specific beam failure recovery SR ID and the control resource pool index are different from the configuration value of the cell-specific beam failure recovery SR ID.

26. The method according to the appendix 22, wherein the method further includes:
when an MAC entity of a terminal equipment has a pending SR for a TRP-specific BFR, and for an SR transmission occasion, the MAC entity has one or more PUCCH resources overlapping with PUCCH resources of the TRP-specific BFR, the MAC entity determines (deems) that the PUCCH resources of the TRP-specific BFR are valid; or
when an MAC entity of a terminal equipment has a pending SR for a secondary cell/TRP-specific BFR, and for an SR transmission occasion, the MAC entity has one or more PUCCH resources overlapping with PUCCH resources of the secondary cell/TRP-specific BFR, the MAC entity determines (deems) that the PUCCH resources of the secondary cell/TRP-specific BFR are valid.

27. The method according to the appendix 22, wherein the method further includes:
in the case where the terminal equipment transmits an MAC PDU and the MAC PDU includes a beam failure recovery MAC CE or a truncated beam failure recovery MAC CE, the beam failure recovery MAC CE or the truncated beam failure recovery MAC CE includes beam failure information of a cell, the MAC entity of the terminal equipment cancels the pending SR triggered for the BFR of the TRP included in the cell and stops the respective prohibiting timer;
in the case where the terminal equipment transmits an MAC PDU, and the MAC PDU includes an MAC CE that includes beam failure information for a TRP, the MAC entity of the terminal equipment cancels the pending SR triggered for the BFR of the TRP and stops the respective prohibiting timer;
or once a secondary cell is deactivated, the MAC entity of the terminal equipment cancels the pending SR triggered for the BFR of the TRP included in the secondary cell;
or the MAC entity of the terminal equipment cancels the triggered pending SR if all TRP-specific BFRs of the triggered SR are cancelled;
or upon SR resource reconfiguration, the MAC entity of the terminal equipment cancels the pending SR.

28. The method according to the appendix 22, wherein the method further includes:
in the case where an MAC PDU performs transmission using an uplink grant except an uplink grant provided by random access response (RAR) or an uplink grant determined from the transmission of the message A payload (MSGA payload), and the MAC PDU includes an MAC CE including beam failure information of a TRP, the MAC entity of the terminal equipment stops the ongoing random access procedure due to the pending SR for the BFR of the TRP.

29. The method according to any of the appendixes 1 to 28, wherein the method further includes:
the MAC entity of the terminal equipment determines whether the beam failure instance indication is cell specific or cell level; and
in the case where the beam failure instance indication is not cell specific or cell level, starts or restarts a transmission reception point (TRP)-specific beam failure detection timer.

30. The method according to any of the appendixes 1 to 28, wherein the method further includes:
the MAC entity of the terminal equipment determines whether the beam failure instance indication is TRP specific or TRP level; and
in the case where the beam failure instance indication is TRP specific or TRP level, starts or restarts the transmission reception point (TRP)-specific beam failure detection timer.

31. The method according to the appendix 29 or 30, wherein the method further includes:
in the case where the beam failure instance indicates whether it is cell specific or cell level, or not TRP specific or TRP level,
a cell-specific beam failure indication count is incremented by 1; and
in a case where the cell-specific beam failure indication count is greater than or equal to the cell-specific beam failure instance maximum count, it is determined that a beam failure of the cell is detected or a beam failure recovery of the cell is triggered or a beam failure indication of the cell is triggered.

32. The method according to the appendix 31, wherein the method further includes:
starting or restarting a cell-specific beam failure detection timer in the case where the MAC entity receives a beam failure instance indication;
resetting the cell-specific beam failure indication count or setting the cell-specific beam failure indication count to 0 in the case where the cell-specific beam failure detection timer has expired.

33. A method for detecting beam failure, including:
a medium access control (MAC) entity of a terminal equipment detects that a beam failure occurs at a transmission reception point or in a cell, or that the beam failure recovery (BFR) at the transmission reception point or in the cell is triggered, or that beam failure indication of the transmission reception point or the cell is triggered; and
the MAC entity of the terminal equipment instructs the multiplexing and assembly entity to generate a beam failure recovery MAC CE or a beam failure MAC CE.

34. The method according to the appendix 33, wherein the MAC entity of the terminal equipment determines whether evaluation of the candidate beam is completed only when the candidate beam is configured.

35. The method according to the appendix 33 or 34, wherein if the beam failure recovery procedure determines that at least one beam failure recovery has been triggered and is not cancelled, or a beam failure is detected, or at least one beam failure indication is triggered and is not cancelled, and if a candidate beam list is configured and evaluation of at least one reference signal in the candidate beam list has been completed, the MAC entity of the terminal equipment instructs the multiplexing and assemble entity to generate the beam failure recovery MAC CE or the beam failure MAC CE.

36. The method according to the appendix 33 or 34, wherein,
if the beam failure recovery procedure determines that at least one beam failure recovery has been triggered and is not cancelled, or a beam failure is detected, or at least one beam failure indication is triggered and is not cancelled, if a candidate beam is configured and evaluation of the candidate beam has been completed,
if the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
otherwise, a scheduling request (SR) for the beam failure recovery or the beam failure is triggered for each cell or TRP that has triggered BFR and has not been cancelled.

37. The method according to the appendix 33 or 34, wherein if the beam failure recovery procedure determines that at least one beam failure recovery has been triggered and is not cancelled, or a beam failure is detected, or at least one beam failure indication is triggered and is not cancelled, and if a candidate beam is not configured, the MAC entity of the terminal equipment does not determine whether the evaluation of the candidate beam is completed.

38. The method according to the appendix 33 or 34, wherein,
if the beam failure recovery procedure determines that at least one beam failure recovery has been triggered and is not cancelled, or a beam failure is detected, or at least one beam failure indication is triggered and is not cancelled,
if a candidate beam is configured and evaluation of the candidate beam has been completed, or a candidate beam is not configured,
if the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
otherwise, a scheduling request (SR) for the beam failure recovery or the beam failure is triggered for each cell or TRP that has triggered BFR and has not been cancelled.

39. The method according to the appendix 33, wherein the cell or the TRP is configured with beam failure recovery or with beam failure recovery parameters, and/or is configured with beam failure detection or with beam failure detection parameters;
for each cell/TRP configured with beam failure recovery or with beam failure recovery parameters, and/or configured with beam failure detection or with beam failure detection parameters, the MAC entity will determine whether to instruct generation of an MAC CE or trigger a scheduling request (SR).

40. The method according to the appendix 33, wherein for each cell/TRP configured with beam failure recovery, or for each cell/TRP configured with beam failure recovery parameters, the MAC entity performs the following operations:
if the beam failure recovery procedure determines that at least one beam failure recovery has been triggered and is not cancelled, or a beam failure is detected, or at least one beam failure indication is triggered and is not cancelled, and evaluation of the candidate beam has been completed,
if the uplink resource is available for a new transmission and if the uplink resource can accommodate a beam failure recovery MAC CE or a beam failure MAC CE plus its sub-header as a result of LCP, the MAC entity instructs the multiplexing and assembly procedure to generate the beam failure recovery MAC CE or the beam failure MAC CE;
otherwise, if the uplink resource is available for a new transmission and if the uplink resource can accommodate a truncated beam failure recovery MAC CE or a beam failure MAC CE plus its sub-header as a result of LCP, the MAC entity instructs the multiplexing and assembly entity to generate the truncated beam failure recovery MAC CE or the beam failure MAC CE;
otherwise, a scheduling request (SR) for the beam failure recovery or the beam failure is triggered for each cell or TRP that has triggered BFR and has not been cancelled.

41. The method according to the appendix 33, wherein the cell or the TRP is configured with beam failure recovery or with beam failure recovery parameters, and/or is configured with beam failure detection or with beam failure detection parameters;
for each cell/TRP configured with beam failure recovery or with beam failure recovery parameters, and/or configured with beam failure detection or with beam failure detection parameters, the MAC entity will perform beam failure detection to trigger the BFR.

42. The method according to the appendix 41, wherein the method further includes:
the MAC entity receives a beam failure instance indication;
starting or restarting a cell-specific beam failure detection timer;
incrementing a cell-specific beam failure indication count by 1; and
in a case where the cell-specific beam failure indication count is greater than or equal to the cell-specific beam failure instance maximum count, it is determined that a beam failure of the cell is detected or a beam failure recovery (BFR) of the cell is triggered or a beam failure indication of the cell is triggered.

43. The method according to the appendix 41, wherein the method further includes:
the MAC entity receives a beam failure instance indication;
starting or restarting a TRP-specific beam failure detection timer;
incrementing a transmission reception point (TRP)-specific beam failure indication count by 1; and
in a case where the TRP-specific beam failure indication count is greater than or equal to a TRP-specific beam failure instance maximum count, determining that a beam failure occurs in a transmission reception point or beam failure recovery (BFR) of the transmission reception point is triggered or a beam failure indication of the transmission reception point is triggered.

44. The method according to any of the appendixes 33 to 43, wherein the method further includes:
the MAC entity of the terminal equipment determines that the evaluation of the candidate beam has been completed if the candidate beam is not configured in the case where at least one beam failure recovery is triggered.

45. The method according to any of the appendixes 33 to 43, wherein the method further includes:
the physical layer of the terminal equipment, upon receiving the higher layer request, determines that the evaluation of the candidate beam has been completed in the case where the candidate beam is not configured.

46. The method according to any of the appendixes 33 to 43, wherein in a case where a reference signal for beam failure detection is configured, a candidate reference signal is configured.

47. A terminal equipment, including a memory and a processor, the memory storing a computer program, the processor being configured to execute the computer program to implement the method for detecting beam failure according to any of the appendixes 1 to 46.

48. A communication system, including:
a terminal equipment, configured to receive a beam failure instance indication by a medium access control (MAC) entity, increment a transmission reception point (TRP)-specific beam failure indication count by 1, and in a case where the TRP-specific beam failure indication count is greater than or equal to a TRP-specific beam failure instance maximum count, determine that a beam failure occurs in a transmission reception point or beam failure recovery (BFR) of the transmission reception point is triggered or a beam failure indication of the transmission reception point is triggered; and
a network device which receives a beam failure recovery MAC CE or a beam failure MAC CE.

What is claimed is:

1. An apparatus for detecting beam failure for a beam failure detection reference signal (BFD-RS) set of a serving cell, the apparatus comprising:
a receiver configured to receive a beam failure instance indication in each of two beam failure detection reference signal (BFD-RS) sets configured for a serving cell; and
processor circuitry configured to:
increment, when the receiver receives a beam failure instance indication in a BFD-RS set which is included in the two BFD-RS sets, a beam failure indication count of the BFD-RS set by 1,
trigger, in a case where the beam failure indication count of the BFD-RS set is greater than or equal to a beam failure instance maximum count for BFD-RS set, beam failure recovery (BFR) for the BFD-RS set of the serving cell,
trigger a scheduling request (SR) used for the BFR of the BFD-RS set for which the BFR is triggered and not cancelled, the SR being indicated by a SR ID or a group of SR IDs for the BFR, and
determine that the PUCCH resources of the BFR of the BFD-RS set are valid when a medium access control entity has pending SR for a BFR of a BFD-RS set and the MAC entity has one or more physical uplink control channel (PUCCH) resources overlapping with PUCCH resources of the BFR of the BFD-RS set for a SR transmission occasion.

2. The apparatus according to claim 1, wherein
the processor circuitry is further configured to start or restart a beam failure detection timer of the BFD-RS set in a case where the receiver receives a beam failure instance indication; and
in a case where the beam failure detection timer of the BFD-RS set expires, set the beam failure indication count of the BFD-RS set to be 0.

3. The apparatus according to claim 1, wherein the medium access control entity instructs a multiplexing and assembling entity to generate a transmission reception point-specific beam failure recovery medium access control control element.

4. The apparatus according to claim 3, wherein the medium access control entity determines whether evaluation of one or more candidate beams is completed when the one or more candidate beams are configured.

5. The apparatus according to claim 1, wherein for each serving cell configured for beam failure detection, the medium access control entity performs beam failure detection to trigger the beam failure recovery for the beam failure detection reference signal set.

6. The apparatus according to claim 1, wherein the medium access control entity determines whether the transmission reception point belongs to a secondary cell, and in a case where the transmission reception point belongs to a secondary cell, determines that a beam failure occurs in the transmission reception point or beam failure recovery of the transmission reception point is triggered or a beam failure indication of the transmission reception point is triggered.

7. The apparatus according to claim 6, wherein the medium access control entity determines whether beam failure recovery of all transmission reception points configured with transmission reception point-specific beam failure detection is triggered, and in a case where beam failure recovery of all transmission reception points configured with transmission reception point-specific beam failure detection is triggered, initiates a random access procedure in a special cell.

8. The apparatus according to claim 1, wherein the medium access control entity performs one or any combination of the following operations:
in a case where a medium access control protocol data unit is transmitted and the medium access control protocol data unit includes a transmission reception point-specific beam failure recovery medium access control control element, cancelling all beam failure recovery triggered for beam failure detection reference signal set; or
if a physical downlink control channel addressed to a C-RNTI indicating an uplink grant for a new transmission is received for an HARQ process used for a transmission reception point-specific beam failure recovery medium access control control element, cancelling all beam failure recovery triggered for beam failure detection reference signal set.

9. A terminal apparatus comprising:
a memory; and
processr circuitry coupled to the memory and configured to:
receive, in the media access control (MAC) entity, a beam failure instance indication in each of two beam failure detection reference signal (BFD-RS) sets configured for a serving cell,
increment, when the MAC entity receives a beam failure instance indication in a BFD-RS set which is included in the two BFD-RS sets, a beam failure indication count of the BFD-RS set by 1,
trigger, in a case where the beam failure indication count of the BFD-RS set is greater than or equal to a first value, beam failure recovery (BFR) for the BFD-RS set of the serving cell,
trigger a scheduling request (SR) used for the BFR of the BFD-RS set for which the BFR is triggered and not cancelled, the SR being indicated by a SR ID or a group of SR IDs for the BFR, and
determine that the PUCCH resources of the BFR of the BFD-RS set are valid when the MAC entity has pending SR for a BFR of a BFD-RS set and the MAC entity has one or more physical uplink control channel (PUCCH) resources overlapping with PUCCH resources of the BFR of the BFD-RS set for a SR transmission occasion.
